(19) United States
(12) Patent Application Publication
(10) Pub. No.: US 2019/0291698 A1
(43) Pub. Date: Sep. 26, 2019

(54) System for Defrosting and Shedding Moisture or Debris from Underside of Vehicle

(71) Applicant: Janesville, LLC, Southfield, MI (US)

(72) Inventor: Michael J. Camella, Huron, OH (US)

(21) Appl. No.: 16/362,606

(22) Filed: Mar. 22, 2019

Related U.S. Application Data
(60) Provisional application No. 62/646,593, filed on Mar. 22, 2018.

(51) Int. Cl. B60S 1/68; H05B 1/02; H05B 3/26

(52) U.S. Cl. CPC B60S 1/68; H05B 3/26; H05B 1/0236

(57) ABSTRACT

A system for preventing accumulation of ice, snow, slush, water, other moisture, sand, mud, and debris on an exterior of a vehicle. The system includes vibratory elements and can further include heating elements mounted on or to shedding wheel liners or underbody panels of the vehicle. The system has a controller that can be in communication with one or more accumulation sensors to manually or automatically energize vibratory and heating elements to prevent or shed accumulation when corresponding conditions are sensed by the sensors. A preferred vibratory element is an acoustic transducer that can be a motor or transducer acoustically coupled to a wheel liner or underbody panel in a manner that vibrates the liner or panel when energized. Each liner or panel is equipped with at least a plurality of vibratory elements arranged to relatively uniformly vibrate the liner or panel in a manner that prevents or sheds accumulation.

### CROSS REFERENCE

This application claims priority under 35 U.S.C. § 119(e) in U.S. Provisional Patent Application No. 62/646,593 filed Mar. 22, 2018, the entire disclosure of which is hereby expressly incorporated herein by reference.

### FIELD

The present invention is directed to a system and apparatus for preventing formation or accumulation of moisture, ice and/or other debris exteriorly on a vehicle, and more particularly to a system and apparatus for preventing formulation or accumulation of moisture, ice and/or other debris on or about a wheel liner and/or an underside, e.g., body panel, of a vehicle during use and operation of the vehicle.

### BACKGROUND

A common issue with vehicles involves the accumulation of moisture or debris about the underside of a vehicle. This is especially true during colder months, were snow and ice collect and freeze about wheel liners or underbody panels of the vehicle as seen in FIGS. 1 and 2, which show prior art wheel liners and underbody panels. Previously, the best way to get rid of snow and ice collections located about the vehicle was to manually remove the snow or ice either by chipping away or spraying down the ice and snow. These options would require an individual to stop the vehicle and move about the vehicle in cold weather to remove any undesirable snow or ice accumulations. Additionally, special care would need to be taken where the snow or ice formations were chipped away to avoid damage to the vehicle. Furthermore, it can be difficult to access the underbody panels of the vehicle when snow or ice formations occurred on the underbody panels. Alternatively, the vehicle could be stored in a warm location, such as a heated garage, which would result in the melting of the snow and ice. This is unappealing as it results in the collection of dirty snow and ice on the garage floor.

Excessive collection of water about the underside of a vehicle is also undesirable as it can have negative consequences to the vehicle and more specifically to the electrical systems associated with the vehicle. Additionally, excess collection of water weight negatively affects use of the vehicle. For instance, excess collection of ice, snow, water, and other debris about the vehicle can cause the weight of the vehicle to exceed the Corporate Average Fuel Economy (CAFE) regulations.

Finally, collection of mud, grass, sand, and other types of debris on the underside of the vehicle commonly occurs where the vehicle is used in rough terrain. To avoid damage to the vehicle, these materials are oftentimes removed by repeated vehicle washings, which can be time consuming and costly. Again, it can be a challenge for a user to clean out the underbody panels due to lack of access.

What is needed is a system, apparatus and method that prevents and/or sheds accumulation of a cumulable substance, such as snow, ice, moisture, and/or other debris on the exterior of a vehicle.

### INVENTION SUMMARY

The present invention is directed to a system, apparatus and method of preventing and/or shedding accumulation of a cumulable substance, such as snow, ice, moisture and/or other debris, e.g., mud, on an exterior surface of a vehicle. In a preferred embodiment, the present invention is directed to such a system, apparatus and method of preventing and/or shedding accumulation of an accumulable substance on an exterior panel of a vehicle that preferably is a wheel liner or underbody panel of a wheeled land vehicle, like an automobile, truck, or other type of vehicle having at least a plurality of wheels.

The present invention is directed to a system, apparatus and method of mechanically preventing accumulation and preferably also shedding accumulation of a cumulable substance like moisture, snow, ice or debris, like mud, from an outside or exterior part of a vehicle. In a preferred embodiment, the present invention is directed to a system, apparatus and method of vibrationally, e.g., acoustically, preventing accumulation of an accumulable substance like moisture, snow, ice or debris, e.g., mud, on an exterior surface of the vehicle, and which preferably also vibrationally, e.g., acoustically, sheds such a cumulable substance that has gathered on or which is clinging to an exterior surface of the vehicle.

A preferred embodiment of the system, apparatus and method in accordance with the present invention is further configured to thermally prevent accumulation of such an accumulable substance exteriorly on an exterior surface of a vehicle and preferably also is configured to thermally shed accumulation of substance or substances which has or have accumulated on an outer surface of the vehicle. In such a preferred embodiment, the system, apparatus and method of the present invention is configured to both mechanically, preferably vibrationally, e.g., acoustically, and thermally, e.g., via application of heat, to prevent accumulation of cumulable substances as well as to shed, e.g., remove or expel, substances which have accumulated on an exterior surface of a vehicle.

The present invention is directed to a mechanically shedding and/or thermally defrosting system and method of the invention for defrosting and/or mechanically shedding moisture or debris, such as mud, from an exterior portion of a vehicle. To allow for the defrosting and shedding of moisture and debris which may or has accumulated on the outer surface of an exterior portion of a vehicle, the system preferably includes at least a mechanical shedding subsystem composed of one or more vibratory elements, and which can also be equipped with a thermal defroster shedding subsystem composed of one or more heating elements which can be configured as a defroster(s) mounted to or on the vehicle. The vibratory elements and heating elements help prevent buildup of ice, snow, slush, water, mud, sand, and other debris from accumulating around exterior portions of a vehicle, such as wheel wells and the underbody of the vehicle.

A preferred defroster subsystem is a thermally driven subsystem equipped with one or more heating elements attached to, embedded within, or mounted to any exterior portion of the vehicle where accumulation of ice due to collection of snow, water, or other heat-meltable substance accumulation occurs when the temperature is at or below a threshold accumulation temperature where water will condense and/or where ice, snow or another type of heat-meltable substance accumulates or tends to accumulate. Each heating element converts electricity into heat through the process of resistive heating, Joule heating, or another suitable way of producing heat to either melt that which has accumulated and/or otherwise prevent accumulation of ice, snow or other type of heat-meltable substance.

In a preferred embodiment, one or more heating elements are attached to, disposed within, or mounted on any portion of a wheel well and/or underside of the vehicle where ice, snow or another type of heat-meltable substance accumulates or tends to accumulate when the ambient temperature outside the vehicle is at or below a threshold accumulation temperature that preferably is the ambient freezing or temperature of water, i.e. at or below 32° Fahrenheit or 0° Celsius.

In one preferred embodiment, one or more wheel wells are lined with wheel liners each equipped with one or more such heating elements used to defrost or otherwise thermally shed ice, snow, slush or another heat-meltable substance which accumulates in the wheel well and/or on the wheel liner. During operation, electrical current is supplied to each heating element to raise the temperature of an adjacent portion of the wheel well, preferably the wheel liner, of the vehicle to melt and eventually cause the ice, snow, water, and other moisture to fall off the portion of the vehicle.

In another preferred embodiment, one or more portions or panels of the underbody of the vehicle are each equipped with one or more such heating elements used to defrost or otherwise thermally shed ice, snow, slush or another heat-meltable substance which accumulates on the generally downwardly facing outer surface(s) of the vehicle underbody. During operation, electrical current is supplied to each heating element to raise the temperature of an adjacent portion of the vehicle underbody, preferably underbody panel, equipped with a heating element to melt and eventually cause the ice, snow, water, and other moisture to fall off the portion of the vehicle.

In a still further preferred embodiment, the defroster subsystem can be a thermally driven subsystem configured in firmware, software and/or hardware to not only shed such heat-meltable substance accumulation but which is also configured to prevent accumulation by the heating elements heating the temperature of the heating element equipped outer surface(s) of the wheel liner(s) and/or underbody panel(s) above the (1) dew point or condensation temperature thereby preventing moisture condensation from occurring, and/or (2) freezing temperature thereby preventing moisture from freezing, snow from sticking, and/or snow from sticking.

Such a defroster system preferably is a thermally driven subsystem also includes a source of electrical power, e.g., from the vehicle, used to electrically power the heating elements which can be conveyed to the heating elements via wiring harness or cabling routed through interior portions of the vehicle. Such a defroster system preferably is a thermally driven subsystem configured in firmware, software and/or hardware, such as deployed in a controller which selectively, controllably and/or variably energizes or powers heating elements based on ambient weather conditions outside the vehicle, vehicle safety or operating conditions, and/or sensors or sensing arrangements configured to sense or detect accumulation or conditions indicative of accumulation occurring during vehicle operation. Such a controller can interface with a sensing arrangement provided by a preexisting control system onboard the vehicle and/or a sensing arrangement composed of or linked to one or more sensors, such as one or more temperature sensors, moisture or humidity sensors, pressure sensors, substance accumulation proximity detecting sensors, substance accumulation contact sensors, accumulation weight, mass or load sensing or detecting sensors or load cells, and/or other types of sensors suitable for sensing or detecting the presence or likelihood of accumulation. Signals, data and the like from multiple sensors and/or multiple different types of sensors can be monitored as a group by the controller to determine whether conditions are present indicative or predictive of accumulation occurring causing the controller to energize one or more of the heating elements to prevent or shed accumulation.

A preferred mechanical-shedding subsystem is an oscillatory driven subsystem equipped with one or more vibration elements attached to, embedded within, or mounted to any exterior portion of the vehicle where accumulation of ice due to collection of snow, water, debris, e.g., mud, and other types of substance accumulation occurs during vehicle use and operation. Each vibration element preferably is a vibration motor that more preferably is a linear resonant actuator that vibrates and excites an adjacent external portion of the vehicle to mechanically dislodge and/or mechanically convey accumulated substance(s) shedding the accumulation therefrom. In a preferred embodiment, one or more vibration motors are attached to, disposed within, or mounted on any portion of a wheel well and/or underside of the vehicle where ice, snow, slush, debris or another type of substance accumulates or tends to accumulate. In one preferred embodiment, one or more wheel wells are lined with wheel liners each equipped with one or more such vibration motors used to mechanically convey or otherwise mechanically shed ice, snow, slush, debris, such as mud, or another substance which accumulates or tends to accumulate in the wheel well and/or on the wheel liner. During operation, electrical current is supplied to each vibration motor to produce vibrations therefrom that are transmitted to adjacent portion(s) of the wheel well, preferably the wheel liner, of the vehicle causing water, ice, snow, slush, dust, dirt, mud and the like that has accumulated thereon to vibrate loose, vibrate free and vibrationally move therealong until shed from the vehicle, e.g., falls from or off the vehicle.

In another preferred embodiment, one or more portions or panels of the underbody of the vehicle are each equipped with one or more such vibration motors used to mechanically shed or vibrationally loosen and remove ice, snow, slush, dust, dirt, mud and/or another accumulable substance which accumulates or tends to accumulate on the generally downwardly facing outer surface(s) of the vehicle underbody. During operation, electrical current is supplied to each vibration motor to oscillate, vibrate or excite into vibration an adjacent portion of the vehicle underbody, preferably underbody panel, equipped with at least one vibration to break loose, move, clear, and/or otherwise shed condensed water, ice, snow, slush, dust, dirt, mud and other accumulated matter causing that which has accumulated thereon to fall off the vehicle onto the ground.

In a still further preferred embodiment, the mechanical-shedding subsystem can be a oscillatory driven subsystem configured in firmware, software and/or hardware to not only shed such substance accumulation but which is also configured to prevent accumulation by the vibration motors vibrating adjacent exterior portions of the vehicle at a high enough frequency, oscillatory magnitude, and the like, including at a resonant frequency of the adjacent exterior portion(s) to break free accumulation and convey or walk matter broken free along the exterior vehicle portions until the matter broken free falls off the vehicle downwardly onto the ground. Such a system can also be configured to convey or walk liquid accumulated matter, such as condensed water or another liquid disposed on an outer surface of vibration motor equipped, excited or coupled exterior vehicle portions conveying or walking off the condensed water or liquid downwardly along the outer surface(s) until the water or liquid flows, drips or otherwise falls from the vehicle onto the ground.

Such a mechanical-shedding system preferably is a vibratory driven subsystem that also includes a source of electrical power, e.g., from the vehicle, used to electrically power the vibration motor which can be provided to the vibration motors via wiring harness or cabling routed through interior portions of the vehicle. Such a mechanical-shedding system preferably is a vibration driven subsystem configured in firmware, software and/or hardware, such as deployed in a controller, which selectively, controllably and/or variably energizes or powers vibration motors based on ambient weather conditions outside the vehicle, vehicle safety or operating conditions, and/or sensors or sensing arrangements configured to sense or detect accumulation or conditions indicative of accumulation occurring during vehicle operation. Such a controller can interface with a sensing arrangement provided by a preexisting control system onboard the vehicle and/or a sensing arrangement composed of or linked to one or more sensors, such as one or more temperature sensors, moisture or humidity sensors, pressure sensors, substance accumulation proximity detecting sensors, substance accumulation contact sensors, accumulation weight, mass or load sensing or detecting sensors or load cells, and/or other types of sensors suitable for sensing or detecting the presence or likelihood of accumulation. Signals, data and the like from multiple sensors and/or multiple different types of sensors can be monitored as a group by the controller to determine whether conditions are present indicative or predictive of accumulation occurring causing the controller to energize one or more of the vibration motors to prevent or shed accumulation.

A hybrid or dual-action shedding system constructed and configured in accordance with the present invention can be employed that utilizes a combination of heating elements and vibration motors disposed in one or more exterior portions of the vehicle, such as in wheel wells, e.g., wheel liners, and/or underbody portions, e.g., underbody panels, to work separately and/or in concert with one another to thermally and/or mechanically prevent or shed such accumulation. The controller of such a hybrid or dual action shedding system can be and preferably is configured in firmware, software and/or hardware to selectively and at varying power levels (a) energize one or more vibration motors where it is desired to mechanical shed or prevent accumulation, (b) energize one or more heating elements where it is desired to thermally shed or prevent accumulation, (c) energize one or more vibration motors and heating element substantially simultaneously where it is desired to employ both vibratory and thermal shedding or prevention of accumulation, and/or (d) sequentially energize one or more heating elements before energizing one or more vibration motors where it is desired to heat up and loosen accumulation before vibrationally shedding the accumulation off the vehicle.

Like discussed above in connection with the defroster subsystem that employs heating elements, sensors which can be used with the mechanical shedding subsystem can include thermometers, e.g., temperature sensors, humidity sensors, pressure sensors, load cells and the like. These sensors could be used exclusively with the vibratory motors, or sensors could be used with both heating elements and vibration motors where so equipped with both. When used with vibration motors, an automatic vibratory element actuator or controller can be configured in firmware, software and/or hardware to allow electrical power to flow to the vibration motor(s) when a temperature is sensed that approaches freezing, is at freezing or is slightly above is above freezing to mechanically displace and/or shed water, snow, and slush before it freezes into ice. Similarly, where a temperature is sensed that is below freezing, the heating element(s) can be initially powered at a power level that increases with decreasing temperature to begin the melting of ice, snow, and other moisture located adjacent to the heating element(s). Depending on the temperature measured or sensed, the time before one or more of the vibratory motor(s) is actuated can be calculated so that vibration motor(s) are not actuated until the ice, snow, and other moisture has had a chance to melt due using heating element(s) in a preheating or defrosting cycle. Stated differently, when a temperature is sensed sufficiently below freezing, one or more heating element(s) can be actuated for a longer preheat period or defrost cycle time upon or after which the vibration motor(s) are actuated to shed ice that has been loosened by defrosting ice enough for the ice to then be vibrationally displaced until it slides down and falls free from the vehicle. Where the sensed temperature is warmer but still below freezing, the mechanical shedding pre-heat or defrost cycle time of heating element actuation can be shortened before actuating the vibration motor(s).

Additionally, a humidity sensor could be used to activate the vibration motor(s) when it is likely that moisture is collecting on adjacent exterior portions of the vehicle causing the moisture to be mechanically displaced, conveyed and/or shed from the vehicle before excessive moisture accumulation occurs. Further still, in the event that a load cell is employed that senses an adjacent external force caused by accumulation on a given exterior portion of the vehicle 24, one or more vibration motor(s) adjacent the load-sensed accumulation can be activated to excite into vibration areas adjacent to the vibration motor(s) to break free and encourage movement of such accumulation away therefrom preferably shedding the accumulation from the vehicle.

An accumulation shedding method of the present invention contemplates use of multiple sensors monitored in concert with respect to whether corresponding related threshold(s) or range(s) have been met before activating one or more vibration motors and/or heating elements. Where such multiple sensors are monitored and/or sensor fusion is employed, such as for primarily controlling when energizing of vibration motor(s) occurs, similar temperature, pressure and/or humidity related information or data from a control system of the vehicle itself can be used to facilitate in controlling actuation of the vibration motor(s) as well as the heating element(s).

While such an accumulation system can be constructed using one heating element and/or one vibratory element, e.g., vibration motor, it should be noted that such a system can be composed of a single heating element, a single vibratory element, or a combination of both a single heating element and single vibratory element. It is also contemplated that such a system can further be composed of a combination of multiple heating elements and multiple vibratory elements located in a single wheel liner, a single underbody panel, or in a single other exterior panel of the vehicle particularly those on which accumulation is known to occur or could occur. A shedding system in accordance with the present invention contemplates installation of one or more vibration motors and/or one or more heating elements in any location on or about the vehicle where such accumulation is known to occur or likely to occur.

Such heating elements and/or vibration motors can be installed on or in wheel liners and underbody panels made of any number of different materials, including but not limited to a fibrous material, fiberglass, a plastic material, a synthetic material, composite, or a metallic material. Additionally, it is contemplated that such accumulation-shedding wheel liners and underbody panels can also be made of a conductive material including with metallic coatings, e.g., fibrous material with coated material, used either to improve electrical conductivity and/or used to form heating element(s). Moreover, electrically conductive heat generating wires can be affixed to, embedded in, embedded within, and/or sandwiched within wheel liners and/or underbody panels, such as nichrome wires or the like, which also can form or be used as heating elements.

While the accumulation shedding systems discussed herein do so with respect to use of the shedding system in or with a car, truck or other wheeled vehicle, it should be noted that the system could similarly be used with other vehicles including all types of motor vehicles, including ATVs, UTVs, snowmobiles, and the like. Further still, it is contemplated that such an accumulation shedding system can be used in any context where shedding of accumulation of matter such as ice, snow, water, mud, debris, etc. is desired or needed.

Use of the accumulation shedding system in automotive vehicles advantageously reduces safety issues associated with buildup of such matter around a vehicle, which can otherwise undesirably increase vehicle weight beyond CAFE (Corporate Average Fuel Economy) regulations levels reducing mileage, increasing vehicle wear and tear, adversely impacting location of the vehicle center of mass, decreasing vehicle handing and/or stability, or otherwise undesirably affecting vehicle performance or life, increasing steering component and/or tire wear and tear, and/or leading to sagging of vehicle components due to increased weight and even failure of wheel liners, underbody panels, and other vehicle parts due to excessive weight. As such, use with such an accumulation shedding system of the invention in automotive vehicles advantageously helps maintain weight closer to its dry weight increasing vehicle handling, stability and mileage, decreasing weight-related wear and tear, and the like.

The present invention contemplates an accumulation shedding system that can be readily integrated into or otherwise used with the electronics and/or electrical, e.g., digital, control system of a vehicle employing an accumulation shedding system controller that can be separate or part of the existing control system, e.g., EEC module, of the vehicle. The present invention also contemplates an accumulation shedding system of standalone construction, e.g., of plug-and-play construction, having a controller, one or more oscillatory actuated accumulation shedding subsystems and/or a thermally actuated accumulation shedding subsystems, and/or one or more accumulation shedder panels that are readily installable on a vehicle, either during vehicle manufacture, and/or after manufacture, including as a retrofit system and/or as an add-on value added feature or vehicle option. Where of separate or standalone construction, such an accumulation shedding system can come in the form of a kit that can also be of modular construction with the controller configured to interface with (a) at least a plurality, preferably at least a plurality of pairs, i.e., at least three, of oscillatory actuated accumulation shedding subsystems, and/or (b) at least a plurality, preferably at least a plurality of pairs, i.e., at least three, of thermally actuated accumulation shedding subsystems, each of which can be in the form of (i) an accumulation shedder panel equipped with one or both of at least one oscillatory actuated accumulation shedding subsystem and/or thermally actuated accumulation shedding subsystem, and/or (ii) one or both of at least one oscillatory actuated accumulation shedding subsystem and/or thermally actuated accumulation shedding subsystem in a panel-less arrangement.

One aspect of the present invention can be and preferably is directed to a vehicle defrosting device that includes a heating element mounted about an underside of the vehicle that alleviates issues associated with snow and ice formations about the underside of a vehicle. The vehicle defrosting device additionally includes a power supply, a wire assembly connecting the heating element to the power supply, and an actuator that controls when power is provided to the heating element. Further still, the vehicle defrosting device can include a voltage regulator that optimizes the voltage of electricity from an electrical system of the vehicle to the heating element.

The actuator can be a manual actuator that can be powered on and powered off by a user, or it can be an automatic actuator that is in communication with an accumulation sensor. Where an automatic actuator is used, such as a controller, the controller is electrically connected to such a sensor, such that the controller is triggered by the sensor when certain conditions are met. For instance, the sensor can be a temperature sensor, e.g., thermocouple, which monitors the temperature around the vehicle. When the temperature sensor reads a certain predetermined temperature, such as freezing, the controller can provide power to the heating element. This prevents ice formation about the vehicle. Additional sensors can be used either in combination with a temperature sensor or in isolation, including humidity or moisture-monitoring sensors.

The heating element can be mounted in various locations about the vehicle where snow collection and ice formation occur, including in, around, or adjacent to wheel liners and underbody panels of the vehicle. Such heating elements preferably are thermally coupled thereto by being mounted to, on or in, e.g., embedded in, the wheel liners and/or underbody panels. These wheel liners and/or underbody panels can be made of a conductive material to further increase heat movement in and around the wheel liners and/or underbody panels.

Additionally, the present invention can be directed to a vehicle collection prevention system including at least one vibratory element, preferably a plurality of vibratory elements, and more preferably at least a plurality of pairs, i.e., at least three vibratory elements, to prevent the pooling or collection of water, snow, ice, mud, sand, or other debris. The vibratory element can be mounted about an underside of the vehicle, for instance in, around, or adjacent to wheel liners and underbody panels of the vehicle. In a preferred embodiment, the vibratory elements are mounted to, on or in, e.g., embedded in, the wheel liners and/or underbody panels of the vehicle. In a preferred embodiment, each wheel liner and underbody panel of the vehicle has at least a plurality and preferably a plurality of pairs, i.e., at least three, spaced apart vibratory elements mounted on, to or in each wheel liner and underbody panel. The vehicle collection prevention system can also include a power supply, a wire assembly that connects the power supply to the vibratory element, and an actuator that preferably is a controller that allows the power supply to provide power to the vibratory element to energize it to vibrate the wheel liner or underbody panel carrying the vibratory element. Much like the heating element discussed above, the actuator associated with the vibratory element can be manual, such as a manually operable switch, or an automatic controller. Where an automatic controller is used as an actuator, the controller is connected to a sensor. For instance, the sensor can be a load cell that monitors forces about the vehicle with the sensor configured to sense a load indicative of accumulation of an accumulable substance, such as water, snow, slush, ice, dirt, sand, mud or other debris clinging to an external vehicle surface adjacent the sensor. This can include any downward forces associated with the collection or pooling of water, snow, ice, dirt, sand, or other debris about the vehicle. Once a predetermined weight is sensed by the load cell, the actuator can supply the vibratory element with power such that a portion of the vehicle is excited resulting in the removal or displacement of the water, snow, ice, dirt, sand, or other debris from the vehicle. Alternatively, the sensor could be a thermometer. This could be used to determine when freezing temperatures occur about the vehicle, in which case the vibratory element could be used to prevent moisture from accumulating around the element, which could eventually freeze. Further still, the actuator can be synched with an anti-lock brake mechanism associated with the vehicle in which case power would be supplied to the vibratory element any time the anti-lock brake mechanism pulsed. Again, multiple sensors can be used simultaneously to determine when the actuator should be actuated.

Of course, the heating element described above and the vibratory element could be used together in a vehicle moisture or debris collection prevention system, or in isolation. For instance, the heating element and the vibratory element could be used at the same time to melt and remove moisture from about the underside of the vehicle. Alternatively, the heating element could first be used to melt any snow or ice formations from the underside of the vehicle, followed by the actuation of the vibratory element to remove the melted snow and ice. In such a system, a plurality of sensors and actuators could be used to determine when the heating element and/or vibratory element would be powered.

Various other features, advantages, and objects of the present invention will be made apparent from the following detailed description and any appended drawings.

### DRAWINGS DESCRIPTION

One or more preferred exemplary embodiments of the invention are illustrated in the accompanying drawings in which like reference numerals represent like parts throughout and in which:

FIG. 1 is a perspective view of a wheel liner of a vehicle having an outer wheel liner surface on which a temperature dependent cumulable substance, in the form of frozen water, snow, ice and/or slush, has accumulated;

FIG. 2 is a perspective view of an underbody panel of the vehicle having a generally downwardly facing outer surface on which such a temperature dependent cumulable substance, in the form of frozen water, snow, ice and/or slush, has accumulated;

FIG. 3 is schematic diagram of a vibration driven accumulation preventing or shedding subsystem of one embodiment of a substance accumulation preventing or shedding system constructed in accordance with the present invention;

FIG. 4 is a schematic diagram of a heat driven accumulation preventing or shedding subsystem of another embodiment of a substance accumulation preventing or shedding system constructed in accordance with the present invention;

FIG. 5 is a schematic diagram of a hybrid or dual-action accumulation preventing or shedding subsystem of a further embodiment of a substance accumulation preventing or shedding system constructed in accordance with the present invention constructed to prevent or shed accumulation through heat or vibration, or heat and vibration;

FIG. 6 is a perspective view of a three-dimensionally contoured accumulation shedding wheel liner equipped with an accumulation shedding system of the present invention configured to defrost and/or mechanically shed moisture or debris from an underside of a vehicle to which the wheel liner is attached; and

FIG. 7 is a perspective view of a vibratory element for use with the inventive system for defrosting and shedding moisture or debris of FIG. 6.

Before explaining one or more embodiments of the invention in detail, it is to be understood that the invention is not limited in its application to the details of construction and the arrangement of the components set forth in the following description or illustrated in any appended drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

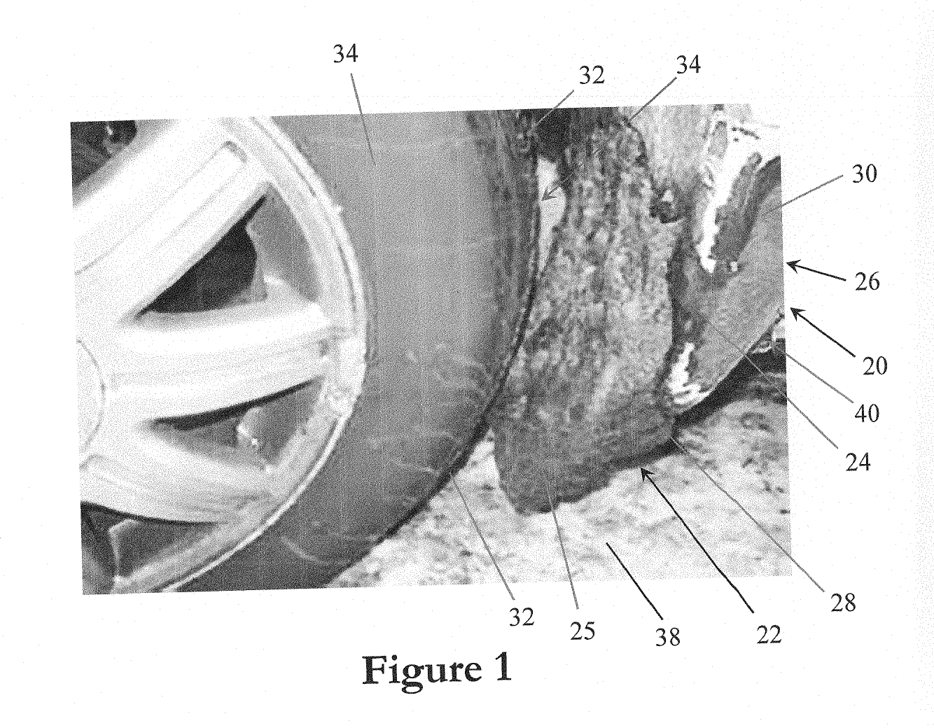

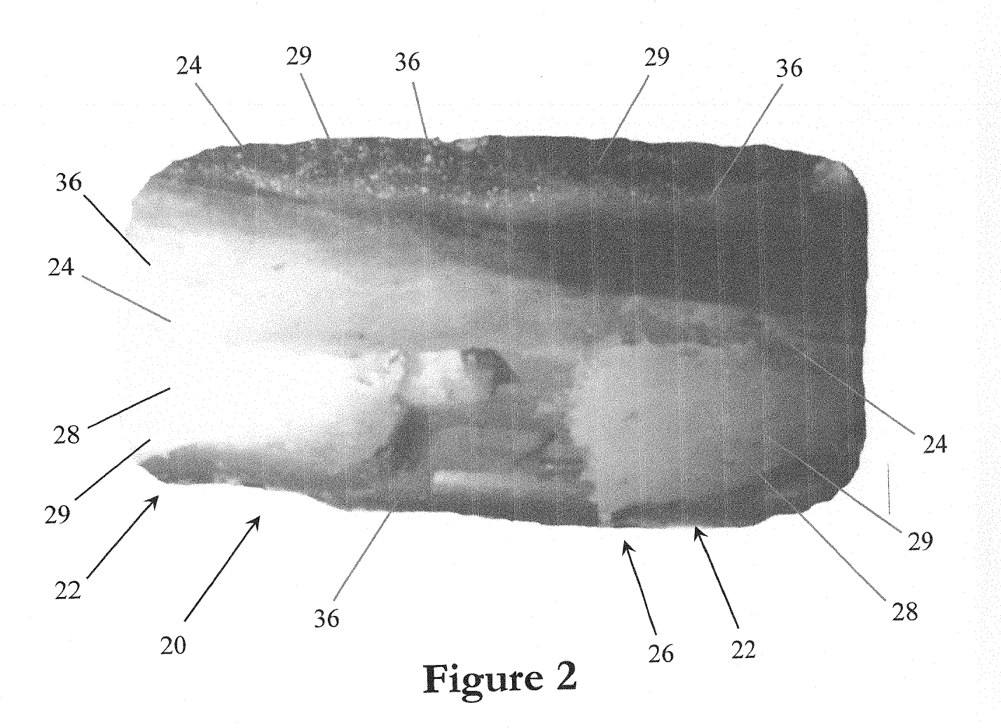

With reference to FIG. 1, the present invention is directed to remedying a long-standing problem in motor vehicles, such as the automobile motor vehicle 20 shown in FIG. 1, where a cumulable substance 22, such as a liquid cumulable substance, typically water, e.g., moisture, tends to buildup on an outer surface 24 of one or more exterior portions 26 of the vehicle 20 by helping to prevent and/or shed such accumulation. As discussed in more detail below, the present invention is directed to a system and method for shedding accumulation, which can be and preferably is configured for preventing accumulation, of any such substance 22, including temperature-induced substance accumulation of a temperature-dependent cumulable substance 28, like slush, snow or ice 29, e.g. frozen water, which can accumulate on an outer surface 24 of one or more such exterior portions 26 of the vehicle 20, including on one or more generally vertically extending convexly curved or arcuately shaped wheel liners 30, which are each disposed in a vehicle wheel well 25 rearwardly of and have an outer surface 24 facing toward a radially outermost tire-tread surface 32 of an adjacent corresponding vehicle wheel 34. With additional reference to FIG. 2, such an accumulation shedding system and method of the present invention can also be constructed and arranged and/or otherwise configured to shed accumulation and/or prevent accumulation of any such substance 22, including temperature-induced substance accumulation of a temperature-dependent cumulable substance 28, like slush, snow or ice 29, which can accumulate on an outer surface 24 of other exterior portions 26 of the vehicle 20 including on one or more generally horizontal vehicle underbody panels 36, which are each disposed underneath the vehicle 20 and have an outer surface 24 that faces downwardly toward the road, floor or ground 38 upon which the vehicle 20 is supported and/or over which the vehicle 20 travels.

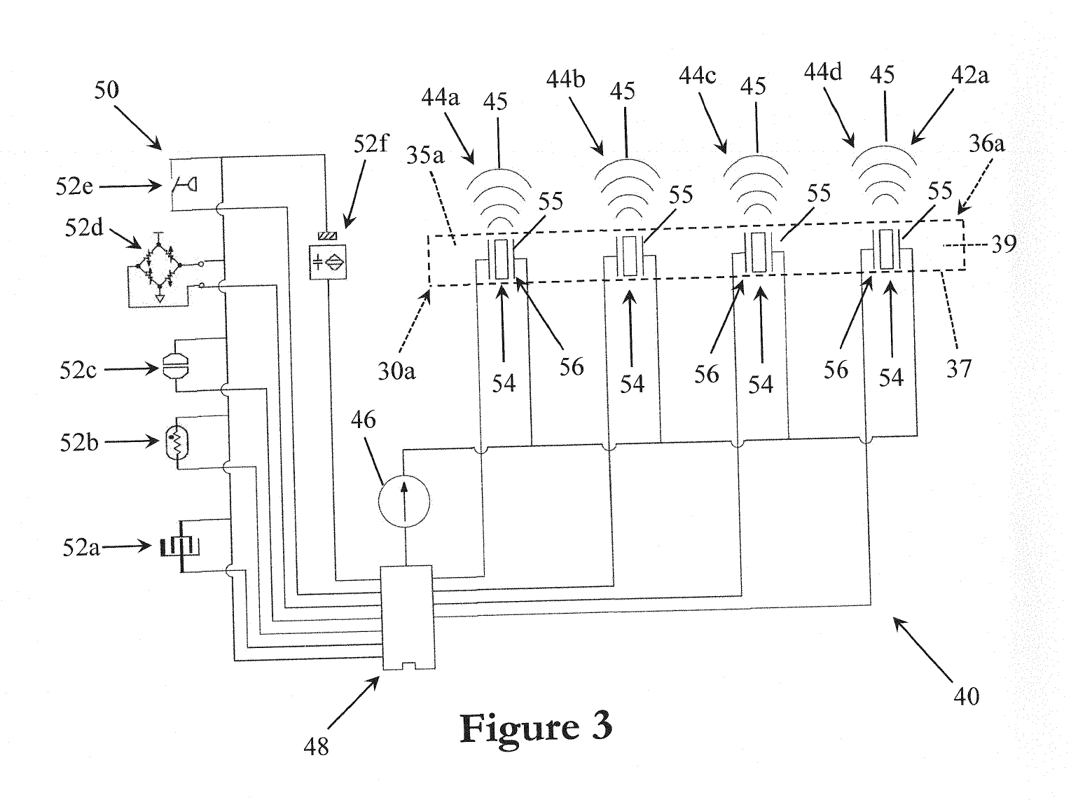

With reference to FIGS. 3-5, the present invention is therefore preferably directed to a system 40 and method for shedding accumulation and/or preventing accumulation of any substance 22 that can accumulate on or along at least one portion of an exterior of a vehicle 20 that preferably is a wheeled motor vehicle, like an automobile, truck, semi-tractor, van, ATV, UTV, motorcycle, or the like, having at least a plurality of wheels 34 driven by a prime mover, such as an internal combustion engine, during vehicle operation. A preferred accumulation shedding system 40 can and preferably does have at least one accumulation shedding subsystem 42a and/or 42b in operable cooperation with one or more exterior portions 26 of the vehicle 20 on which the accumulation shedding system 40 has been installed with a preferred accumulation shedding method operating at least one accumulation shedding subsystem 42a and/or 42b of the system 40 in a manner that sheds accumulation of a cumulable substance 22 that has built up or otherwise accumulated on outer surface(s) 24 of exterior portion(s) 26 of the vehicle 20 adjacent thereto. Operation of such an accumulation shedding system 40 of the invention in carrying out a shedding accumulation method in accordance with the present invention can and preferably does help improve at least one or more of traction, stability, handling, performance and/or fuel efficiency of the vehicle 20 equipped with the system 40.

In one preferred accumulation shedding system 40 and method, the system 40 has at least one accumulation shedding subsystem 42a and/or 42b in operable cooperation with one or more spaced apart exterior portions 26 of the vehicle 20 and is configured to carry out a method during system operation that (a) prevents accumulation of a cumulable substance 22 from occurring when conditions during which accumulation ordinarily would occur have been sensed or otherwise detected, e.g., sensed or detect by or with the system 40, (b) sheds accumulation of the cumulable substance 22 where accumulation of the substance 22 has been sensed or otherwise detected, e.g., sensed or detect by or with the system 40, (c) both prevents accumulation and sheds accumulation of the cumulable substance where accumulation has been sensed or detected such as by, with or using the system 40. As discussed in more detail below, one such preferred accumulation shedding system 40 includes an accumulation sensing arrangement 50, such as including and/or in the form of one or more accumulation sensors 52a, 52b, 52c, 52d, 52e and/or 52f, which are used in sensing, detecting or otherwise determining when a cumulable substance 22, including a temperature-dependent cumulable substance 28, has begun accumulation on an outer surface 24 of an exterior portion 26 of the vehicle 20 and/or has accumulated to a degree or amount at or greater than which that serves as an accumulation system trigger threshold at which operation of the accumulation shedding system 40 is initiated to shed or remove accumulation of a cumulable substance 22, e.g., temperature-dependent cumulable substance 28, which has accumulated on the vehicle exterior.

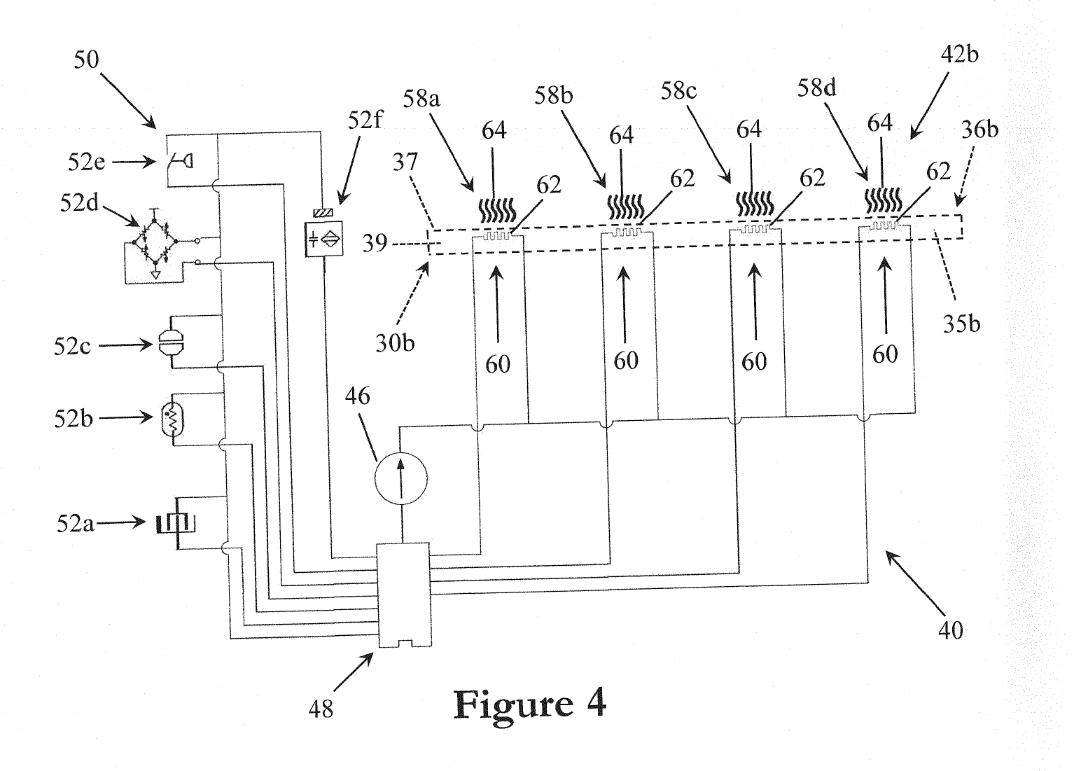

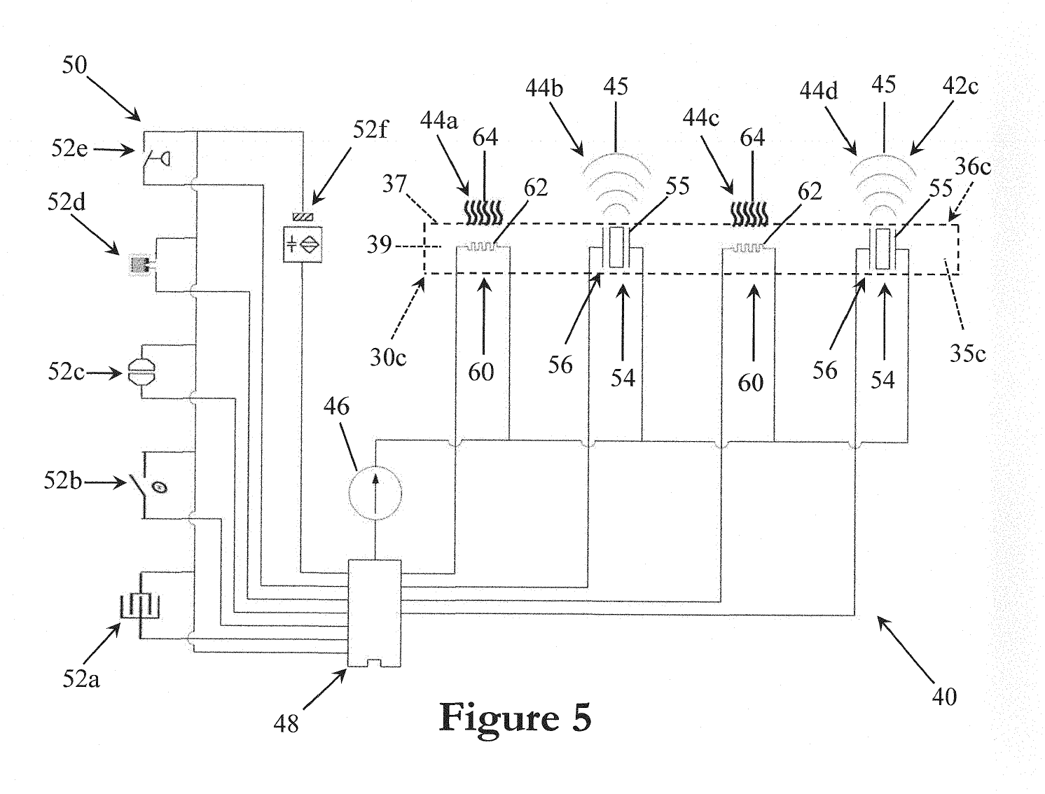

With continued reference to FIGS. 3-5, an accumulation shedding system 40 constructed in accordance with the present invention has at least one accumulation shedding subsystem that can be or include (a) an oscillatory driven accumulation shedding subsystem 42a, such as is depicted in FIG. 3, (b) a thermally driven accumulation shedding subsystem 42b, such as is depicted in FIG. 4, and/or (c) a dual-action oscillatory and thermally driven accumulation shedding subsystem 42c, such as is depicted in FIG. 5, comprised of portions of the oscillatory and thermally driven subsystems 42a and 42b. If desired, an accumulation shedding system 40 of the present invention can have one or more oscillatory driven subsystems 42a, one or more thermally driven subsystems 42b, and/or one or more dual-action driven subsystems 42c used with or in the same or common external portion 26 of the vehicle 20 and/or which can be spaced apart and used with or in multiple external portions 26, e.g., used with or in a plurality of wheel liners 30 and/or underbody panels 36, of the vehicle 20. If desired, one or more external portions 26 of the vehicle 20, including one or more wheel liners 30 and/or one or more underbody panels 36, can be equipped with or otherwise include (a) one or more oscillatory driven subsystems 42a (b) one or more thermally driven subsystems 42b, (c) one or more dual-action driven subsystems 42c, and/or (d) a plurality of (i) oscillatory driven subsystems 42a, (ii) thermally driven subsystems 42b, and/or (iii) dual-action driven subsystems 42c.

FIG. 3 schematically depicts a preferred but exemplary embodiment of an accumulation shedding system 40 of the present invention that is equipped with at least one accumulation shedding subsystem that preferably is an oscillatory-driven accumulation shedding subsystem 42a that has at least one, preferably at least a plurality, and more preferably at least a plurality of pairs of, i.e., at least three, oscillatory drivers 44a, 44b, 44c and/or 44d powered by an electrical current source 46 and whose operation is controlled by a processor-equipped controller 48 configured, such as in firmware, software or hardware, to electrically power at least one of the oscillatory drivers 44a, 44b, 44c and/or 44d to energize at least one of the oscillatory drivers 44a, 44b, 44c and/or 44d when it is desired to shed a substance 22 that has accumulated on an external part 26 of the vehicle 20 and/or to prophylactically prevent substance accumulation via application of acoustic or vibrational energy 45 thereto outputted by drivers 44a, 44b, 44c and/or 44d. Each oscillatory driver 44a, 44b, 44c and/or 44d is vibrationally or acoustically coupled to an exterior portion 26 of the vehicle 20 to cause the exterior surface 27 thereof to oscillate or vibrate at a great enough amplitude and high enough frequency to prevent accumulation or even shed accumulation of accumulable substance 22, such as a temperature-dependent cumulable substance 28, e.g., slush, snow or ice 29, on the surface 27 of the external portion 26 of the vehicle. In a preferred embodiment, each oscillatory driver 44a, 44b, 44c and/or 44d is acoustically or vibrationally coupled to an exterior portion 26 of the vehicle 20 oscillating or vibrating the exterior surface 27 at a great enough amplitude and high enough frequency when energized to prevent accumulation or even shed accumulation of accumulable substance 22, such as temperature-dependent cumulable substance 28, e.g., slush, snow or ice 29, on the surface 27 of the external portion 26 of the vehicle.

The system 40 and/or each subsystem 42a can and preferably does include a cumulable substance sensing arrangement 50 composed of at least one sensor, such as a temperature sensor, a pressure sensor, e.g., air pressure or barometric pressure sensor, a moisture sensor, e.g., a humidity sensor, and/or a load sensor, linked to the controller 48 with the sensing arrangement 50 and/or controller 48 configured, such as in firmware, software and/or hardware, to detect or sense (a) the presence of a cumulable substance 22, such as a temperature-dependent substance 28, e.g., condensed, freezing and/or frozen moisture or water 29, which has already accumulated at or on one or more exterior portions 26 of the vehicle 20, (b) accumulation or the beginning of accumulation a cumulable substance 22, such as temperature-dependent substance 28, at or on one or more of the exterior portions 26 of the vehicle 20, and/or (c) ambient conditions externally of the vehicle 20 which are indicative, e.g., predictive, of a cumulable substance 22, such as temperature-dependent substance 28, accumulating or beginning to accumulate at or on one or more of the exterior portions 26 of the vehicle 20. The electrical components of the accumulation shedding system 40 preferably are connected to an electrical power source 46 that can be and preferably is either part of or otherwise connected to the onboard electrical power system (not shown) of the vehicle 20, e.g., connected to a 12 volt, 24 volt or 48 volt vehicle electrical system (not shown).

The controller 48 has an onboard processor, such as a microprocessor, microcontroller, and/or field programmable gate array (FPGA) configured in software, firmware and/or hardware with a method of operating the accumulation shedding system 40 to prevent or shed accumulation in accordance with the invention used to control operation of oscillatory drivers 44a, 44b, 44c and/or 44d during vehicle operation. Controller 48 can also include one or more additional electrical components, such as onboard memory storage, e.g., RAM, flash memory, etc., an onboard drive, e.g., hard drive, SSD drive, flash drive, etc., onboard wireless communications, e.g., Bluetooth, Wi-Fi, etc., communication ports, e.g., serial ports, parallel ports, SCSI ports, USB ports, etc. as well as other digital or analog control related systems and subsystems onboard the controller 48.

Such a controller 48 can be a pre-existing controller, e.g., a control module assembled to the vehicle 20 during vehicle manufacture, disposed onboard the vehicle, such as a powertrain control module, e.g., PCM module, and/or engine control module, e.g., EEC module, ECU, safety control module, chassis electronics control module, passenger comfort control module, or another onboard vehicle controller or control module that is configured or further configured in its firmware, software, and/or hardware with at least a portion of a preferred accumulation shedding system method in accordance with the invention. If desired, the controller 48 can be a controller separate from pre-existing onboard controllers or control modules of the vehicle that can be linked via a vehicle bus, e.g. CANBUS, or connected in another manner, e.g., wirelessly linked or wirelessly networked, to at least one of the pre-existing onboard vehicle control systems, vehicle control modules or other vehicle controllers or can be separate from all the vehicle control systems, vehicle control modules, and other vehicle controllers. If desired, the controller 48 can be a component or module separate and independent from any and all of the onboard vehicle control systems, vehicle control modules, and other vehicle controllers with the controller 48 and the rest of the electrical components of the accumulation shedding system 40 preferably powered by the onboard electrical power system of the vehicle 20.

Where system 40 is manufactured for retrofit to a vehicle 20, such an aftermarket system 40 can be and preferably includes one or more sensor and/or driver mounts, controller anchor(s), and other hardware which is not shown, is configured in firmware, software and/or hardware, as well as has wiring, e.g., wiring harnesses, and the like, which also is not shown, producing a retrofit or aftermarket accumulation substance shedding system 40 in accordance with another aspect of the present invention that is of “plug-and-play” construction having one or more plugs, electrical connectors, and/or the like (not shown) which plug into one or more pre-existing connectors or receptacles of one or more of the electrical systems and/or control systems of the vehicle 20, including to electrically power, link to, network with, or otherwise connect the system 40 thereto or therewith. In at least one preferred embodiment, such an aftermarket plug-and-play accumulation substance shedding system 40 constructed and arranged for vehicle retrofit is provided, manufactured or packaged as a standalone or turnkey system 40 that can also be electrically powered independently from the electrical power system of the vehicle 20 but preferably is configured to readily connect to, e.g., plug into, the onboard electrical power system of the vehicle 20.

As discussed in more detail below, where the system 40 is equipped with, includes or otherwise is linked to a cumulable substance sensing arrangement 50, the sensing arrangement 50 and/or controller 48 is/are configured, such as in firmware, software and/or hardware, with a method of preventing or shedding accumulation of a cumulable substance 22, e.g. temperature-dependent cumulable substance 28, in accordance with the present invention that enables selective and/or variable energization of one or more or all of the drivers 44a, 44b, 44c and/or 44d in response to ambient conditions and/or vehicle operating conditions detected or sensed by, with or using one or more sensors of the sensing arrangement 50 communicated thereby to the controller 48. Where the system 40 has more than one subsystem 42a and/or 42b, a separate sensing arrangement 50 can be employed for each subsystem 42a and/or 42b but more preferably employs or communicates with a single common sensing arrangement 50 for all of the subsystems 42a and/or 42b.

As previously discussed, each sensing system 50 preferably is composed of one or more sensors that preferably includes at least one of a temperature sensor, pressure sensor, e.g., air pressure or barometric pressure sensor, moisture sensor, e.g., humidity sensor, and/or load sensor, linked to the controller 48 with at least the controller 48 configured to selectively and/or variably energize one or more of the drivers 44a, 44b, 44c and/or 44d when sensor signals or data from the sensing arrangement 50 indicates or is indicative of (a) the presence of a cumulable substance 22, such as a temperature-dependent substance 28, e.g., condensed, freezing and/or frozen moisture or water 29, which has already accumulated at or on one or more exterior portions 26 of the vehicle 20, (b) accumulation or the beginning of accumulation a cumulable substance 22, such as temperature-dependent substance 28, at or on one or more of the exterior portions 26 of the vehicle 20, and/or (c) ambient conditions externally of the vehicle 20 which are indicative, e.g., predictive, of a cumulable substance 22, such as temperature-dependent substance 28, accumulating or beginning to accumulate at or on one or more of the exterior portions 26, e.g., external surfaces 27, of the vehicle 20. When one or more such conditions are detected or sensed via or using the sensing arrangement 50, the controller 48 is configured to energize one or more of the oscillatory drivers 44a, 44b, 44c and/or 44d to prevent or shed accumulation of substance 22, e.g. temperature-dependent substance 28, at or on at least one exterior portion 26, e.g. at or on at least one wheel liner 30 or underbody panel 36, of the vehicle 20 in carrying out a preferred method of preventing or shedding accumulation in accordance with the present invention.

The controller 48 preferably also is configured to selectively energize one or more of the oscillatory drivers 44a, 44b, 44c and/or 44d such that one or more of the other drivers 44a, 44b, 44c and/or 44d are either deenergized or energized using less electrical current or power thereby enabling selective operation and/or variably controllable energization of one driver at a time 44a, 44b, 44c or 44d, a plurality of drivers 44a, 44b, 44c and/or 44d at a time, or even a plurality of pairs of, i.e., at least three, drivers 44a, 44b, 44c and/or 44d at a time, during accumulation prevention or shedding operation of system 40. Controller 48 preferably is also further configured to selectively variably energize each one of the oscillatory drivers 44a, 44b, 44c and/or 44d individually, e.g., independently of one another, including by variably supplying electrical current or power to each energized driver 44a, 44b, 44c and/or 44d at one of at least a plurality, preferably at least a plurality of pairs of, i.e. at least three, electrical current or power supply levels thereby enabling selectively variable control by the controller 48 of the magnitude, amplitude, output power, and/or decibel level outputted by each energized driver 44a, 44b, 44c and/or 44d during accumulation prevention or shedding operation of system 40.

In one preferred implementation of a method of preventing or shedding accumulation of a cumulable substance 22, e.g. temperature-dependent cumulable substance 28, the system 40, preferably controller 48, can be and preferably is configured in firmware, software and/or hardware to selectively or variably partially or completely operate the system 40 when the vehicle 20 is not moving and/or not operating, including when the prime mover, e.g., motor or engine, is turned off or deenergized, thereby enabling accumulation shedding and/or accumulation prevention to be carried out using only vehicle battery power as the electrical power source 46 that powers the system 40. In one such method implementation, the controller 48 is configured to selectively energize less than the full number of drivers 44a, 44b, 44c and/or 44d during accumulation prevention or shedding and/or to variably operate one or more of the energized drivers 44a, 44b, 44c and/or 44d at an input electrical current or power level that is less than a maximum electrical current or power level.

Where the system 40 is equipped with and/or otherwise communicates with a sensing arrangement 50, such a sensing arrangement 50 has at least one sensor, preferably employs at least a plurality of sensors, and can include a plurality of pairs of, i.e. at least the, sensors, such as sensors 52a, 52b, 52c, 52d, 52e and/or 52f schematically depicted in FIG. 3, which are connected in parallel to the controller 48 such that the controller 48 separately monitors and receives signals or data from each sensor 52a, 52b, 52c, 52d, 52e and/or 52f independently of, e.g., sequentially of, every other sensor 52a, 52b, 52c, 52d, 52e and/or 52f in real time during system 40 and/or vehicle 20 operation. Controller 48 can be and preferably is configured in firmware, software and/or hardware to monitor each sensor 52a, 52b, 52c, 52d, 52e and/or 52f in real time during operation of system 40 and/or vehicle 20 and energize one or more of drivers 44a, 44b, 44c and/or 44d when or where a sensor signal, sensor value, sensor condition, sensor data, or the like outputted by one or more of the sensors 52a, 52b, 52c, 52d, 52e and/or 52f reaches or exceeds a predefined driver energization threshold, falls within a predefined driver energization range, and/or meets other predefined criteria, such as when compared with or parsed against an driver actuation database, map or the like. As discussed in more detail below, one or more of the sensors 52a, 52b, 52c, 52d, 52e and/or 52f can be a sensor switch configured to open or close when a parameter, characteristic, property or other condition sensed, detected or otherwise monitored by the sensor switch reaches or exceeds a predetermined driver energization trigger preset, state or value and/or falls within a predetermined driver energization trigger preset, state or value range and the controller 48 to energize one or more of the drivers 44a, 44b, 44c and/or 44d when this happens.

Each one of the oscillatory drivers 44a, 44b, 44c and/or 44d is an acoustic or vibratory element that preferably is a vibratory element 55, e.g. vibration motor 54, which more preferably is an eccentric mass or linear resonant actuator 56, disposed in contact or in close enough proximity to an external portion 26 of the vehicle 20, such as wheel liner 30 and/or underbody panel 36, to vibrate or excite into vibrating the outer surface 24 and/or rest of the external portion 26 with a great enough amplitude and/or frequency to prevent or shed accumulation on the outer surface 24. In a preferred embodiment, each one of the vibratory elements 55 is a vibration motor 56 in contact with the wheel liner 30 or underbody panel 36 carrying it thereby vibrationally or acoustically coupling it thereto. If desired, one or more of the vibratory elements 55 can be a piezoelectric transducer in place of vibration motor 54. In a preferred method of operation, each vibratory element 55 can be energized and operated to vibrate the wheel liner 30 or underbody panel 36 carrying it at a variable frequency and variable amplitude controlled to oscillate or vibrate the wheel liner 30 or underbody panel 36 at a resonant frequency thereof to help more efficiently prevent accumulation or shed accumulation.

Each one of the drivers 44a, 44b, 44c and/or 44d of subsystem 42a of system 40 can be attached to, mounted on, embedded in, or otherwise carried by a wheel liner 30 or underbody panel 36 such that energization each driver 44a, 44b, 44c and/or 44d vibrates or excites into vibration at least a portion of the outer surface 24 of the wheel liner 30 or underbody panel 36. Where not disposed in contact with the wheel liner 30 or underbody panel 36, each driver 44a, 44b, 44c and/or 44d preferably is located adjacent thereto in close enough proximity for acoustic or vibrational energy outputted or radiated therefrom to acoustically or vibrationally couple with the wheel liner 30 or underbody panel 36 and excite the wheel liner 30 or underbody panel 36 into vibrating with sufficient amplitude and/or frequency to prevent or shed accumulation on or from the outer surface 24 of the liner 30 or panel 36. In a preferred embodiment, at least one wheel liner 30 and/or underbody panel 36 is equipped with drivers 44a, 44b, 44c and/or 44d each of which is a linear resonant actuator 56 oriented with its axis of oscillatory or vibratory displacement generally perpendicular to the liner 30 or panel 36 to which the linear resonant actuator 36 is disposed adjacent, mounted on, attached to, embedded in, or otherwise carried by helping to optimize acoustic, oscillatory or vibrational coupling with the liner 30 or panel 36.

If desired, part or all of the sensing arrangement 50 can be provided by a pre-existing sensing arrangement already onboard the vehicle 20, e.g. installed during vehicle manufacture, such as at least part of an onboard preexisting sensing arrangement used or otherwise employed by one or more of the onboard controllers or onboard control systems of the vehicle 20 during vehicle operation. In this regard, sensing arrangement 50 can therefore also include or utilize one or more sensors onboard the vehicle 20 which are pre-existing, e.g. installed during vehicle manufacture, and/or which are part of one or more of the vehicle electrical and/or control systems and/or preexisting onboard sensing arrangements of the vehicle 20. Conversely, one or more or all the sensors 52a, 52b, 52c, 52d, 52e and/or 52f of the sensing arrangement 50 schematically shown in FIG. 3 (also depicted in FIGS. 4 and 5) and/or discussed in more detail hereinbelow can likewise be used by or otherwise form part of one or more of the onboard controllers or onboard control systems of the vehicle 20 and/or one or more of any preexisting onboard sensing arrangements thereof, if desired.

With continued specific reference to the sensor arrangement 50 shown in FIG. 3 (also depicted in FIGS. 4 and 5), each one of the sensors 52a, 52b, 52c, 52d, 52e and/or 52f can be of the same type of sensor with the sensors 52a, 52b, 52c, 52d, 52e and/or 52f spaced apart and disposed in at least a plurality of, preferably at least a plurality of pairs of, i.e., at least three, different locations of the vehicle 20. If desired, each one of the sensors 52a, 52b, 52c, 52d, 52e and/or 52f can be mounted on, attached to, embedded in, or otherwise carried by a different external portion 26 of the vehicle 20, such as where each one of the wheel liners 30 and/or underbody panels 36 carries one of the sensors 52a, 52b, 52c, 52d, 52e and/or 52f. In one preferred embodiment, a corresponding sensor 52a, 52b, 52c, 52d, 52e and/or 52f can be mounted on, attached to, embedded in, or otherwise carried by each wheel liner 30 and/or underbody panel 36 which has or otherwise carries at least one subsystem 42a and/or 42b of the system 40 mounted to or otherwise disposed onboard the vehicle 20.

Similarly, sensors 52a, 52b, 52c, 52d, 52e and/or 52f can each represent a sensor pair, e.g., sensor pairs 52a, 52b, 52c, 52d, 52e and/or 52f, or be arranged in sensor pairs 52a and 52b, 52c and 52d, and 52e and 52f, spaced apart from each other, where each sensor pair is formed of the same two different types sensors, such as where each sensor pair is formed of a temperature and pressure sensor, a temperature sensor and moisture/humidity sensor, or the like, with each sensor pair mounted on, attached to, embedded in, or otherwise carried by each wheel liner 30 and/or underbody panel 36 equipped with a subsystem 42a and/or 42b of the system 40 onboard vehicle 20. Likewise, sensors 52a, 52b, 52c, 52d, 52e and/or 52f can each represent a sensor triplet, e.g., sensor triplet 52a, 52b, 52c, 52d, 52e and/or 52f, or be arranged in sensor triplets 52a-52c and 52d-52f, spaced apart from one another, where each sensor triplet is formed of the same three different types sensors, such as where each sensor triplet is formed of (i) a temperature sensor, pressure sensor, e.g. barometric sensor, and moisture/humidity sensor, (ii) a temperature sensor, pressure sensor, e.g. barometric sensor, and load sensor, (iii) a temperature sensor, a cumulable substance sensing contact or proximity sensor, and load cell, or (iv) another sensor triplet formed of the same three different types of sensors with each sensor pair mounted on, attached to, embedded in, or otherwise carried by each wheel liner 30 and/or underbody panel 36 equipped with a subsystem 42a and/or 42b of the system 40 onboard vehicle 20.

In the sensing arrangement 50 of the system 40 schematically depicted in FIG. 3 (also depicted in FIGS. 4 and 5), each one of the sensors 52a, 52b, 52c, 52d, 52e and/or 52f can be and preferably is a different type of sensor with sensor 52a schematically depicted as being or including a:
a. moisture or humidity sensor 52a,
b. temperature sensor 52b,
c. contact sensor 52c,
d. load sensor 52d,
e. pressure sensor 52e, and/or
f. proximity sensor 52f.

In the sensing arrangement embodiment depicted in FIG. 3 (also shown in FIGS. 4 and 5), the moisture or humidity sensor 52a preferably is a humidity sensor that more preferably is a humidity sensor, e.g., humistor, arranged to sense the humidity of ambient atmosphere externally of and/or surrounding the vehicle 20 with the sensor 52a, system 40 and/or controller 48 configured, including in firmware, software and/or hardware to energize one or more of the drivers 44a, 44b, 44c and/or 44d of the subsystem 42a when the humidity of the ambient atmosphere reaches or exceeds a predetermined threshold humidity or falls within a predetermined humidity threshold range indicative of accumulation of a cumulable substance 22, such as condensation of temperature-depending substance 28, beginning or occurring. Where a temperature sensor 52b is employed, the temperature sensor 52b can be a thermistor disposed in contact with an external portion 26 of vehicle 20 and/or the ambient atmosphere externally of and/or surrounding the vehicle 20 with the sensor 52b, system 40 and/or controller 48 configured, including in firmware, software and/or hardware to energize one or more of the drivers 44a, 44b, 44c and/or 44d of the subsystem 42a when the temperature of an adjacent part of the external portion 26 of the vehicle 20 and/or the temperature of the ambient atmosphere reaches or exceeds a predetermined threshold temperature or falls within a predetermined temperature threshold range indicative of accumulation of a cumulable substance 22, such as condensation of temperature-depending substance 28, beginning or occurring.

Where a contact sensor 52c is employed, the contact sensor 52c can be and preferably is disposed in contact with part of an external portion 26 of vehicle 20, e.g., in contact with part of the outer surface 24 of external portion 26, with the sensor 52c, system 40 and/or controller 48 configured, including in firmware, software and/or hardware, to energize one or more of the drivers 44a, 44b, 44c and/or 44d of the subsystem 42a when the sensor 52c outputs a signal, value, data or the like to the controller 48 indicative of a buildup or presence of a cumulable substance 22, such as a temperature-dependent cumulable substance 28 like water, such as by condensing, freezing or otherwise accumulating on the outer surface 24 of the external portion 26 of the vehicle 20 at or adjacent the contact sensor 52c. Where contact sensor 52c is a contact sensor switch, contact with a cumulable substance 22, e.g., temperature-dependent substance 28, which has condensed, frozen or otherwise accumulated on outer surface 24 of external portion 26 of vehicle 20 and in contact with or in sufficiently close proximity for the switch of the contact sensor 52c to close signaling, e.g., interrupting, the controller 48 causing the controller 48 to energize one or more drivers 44a, 44b, 44c and/or 44d operatively connected or coupled to or with part of the same external portion 26 of the vehicle 20 in which the sensor 44c is carried or otherwise disposed.

Where a load sensor 52d is employed, the load sensor 52d can be and preferably is disposed in contact with part of an external portion 26 of vehicle 20, e.g., in contact with part of an outer surface 24 of the external portion 26, with the sensor 52d, system 40 and/or controller 48 configured, including in firmware, software and/or hardware, to energize one or more of the drivers 44a, 44b, 44c and/or 44d of the subsystem 42a when the load sensor 52d senses or detects a load applied on or to the load sensor 52d and/or part of the outer surface 24 at or adjacent the load sensor 52d indicative of buildup or accumulation of enough mass, weight or amount of a cumulable substance 22, such as a temperature-dependent cumulable substance 28, e.g., condensed or frozen water, snow and/or slush 29, sufficient to reach or exceed a load threshold that triggers the load sensor 52d to signal the controller 48. Such a load sensor 52d can be composed of one or more strain gauges or the like, which can be of piezoelectric construction, which preferably is a load cell 52d disposed at, on, in or in contact with part of the external portion 26, preferably part of the outer surface 24 thereof, of the vehicle 20 with such a load cell 52d configured to output a signal the controller 48, e.g., generate a controller interrupt, when it senses or detects a load force applied thereon that reaches or exceeds a predetermined mass, weight or amount trigger threshold indicative of buildup or accumulation of cumulable substance 22.

Where a pressure sensor 52e is employed, pressure sensor 52e can be a gas or air pressure sensor that more preferably can be an ambient or barometric pressure sensor configured or otherwise used to sense an air, ambient and/or barometric pressure of the ambient air adjacent to and/or exteriorly surrounding the vehicle 20. Where the pressure sensor 52e is such an air or gas pressure sensor, e.g., barometric sensor, configured or used to sense the pressure of ambient air outside the vehicle 20, the system 40 and/or controller 48 preferably is configured, such as in firmware, software and/or hardware, to energize one or more of the drivers 44a, 44b, 44c and/or 44d when the sensed or detected ambient or barometric pressure adjacent the exterior of the vehicle 20 reaches or exceeds a predetermined pressure threshold value and/or falls within a predetermined driver trigger pressure range.

In a preferred system and/or sensing arrangement embodiment employing a pressure sensor 52e, sensor 52e preferably is a contact pressure sensor 52e disposed in contact with part of an external portion 26 of vehicle 20, e.g., in contact with part of an outer surface 24 of the external portion 26, with the sensor 52e, system 40 and/or controller 48 configured, including in firmware, software and/or hardware, to energize one or more of the drivers 44a, 44b, 44c and/or 44d of the subsystem 42a when the pressure caused by buildup of a cumulable substance 22, such as a temperature-dependent substance 28, e.g., snow or ice 29, at or adjacent the contact-pressure sensor 42e reaches or exceeds a predetermined contact pressure threshold value or falls within a predetermined contact pressure range indicative of cumulable substance buildup. Where the contact pressure sensor 52e is in the form of a switch-type contact pressure sensor 52e, e.g., in the form of a contact pressure sensing switch, the switch-type contact pressure sensor 52e is configured to close when the sensed or detected pressure applied by accumulating substance 28, e.g., slush, snow or ice 29, is greater than the predetermined contact pressure threshold value or falls within a predetermined contact pressure range indicative of cumulable substance buildup. When the switch-type contact pressure sensor 52e closes, the sensor 52e preferably outputs an electrical signal to the controller 48 and/or generates a controller interrupt, causing the controller 48 to energize one or more drivers 44a, 44b, 44c and/or 44d.

Where a proximity sensor 52f is employed, the proximity sensor can be a capacitive or electrostatic type proximity sensor 52f, e.g., thermoelectric sensor 52f, which is or functions as a proximity sensing switch that closes or otherwise outputs a driver energizing signal to the controller 48 and/or generates a driver energizing controller interrupt when buildup or accumulation of a cumulable substance 22, such as a temperature dependent substance 28, e.g., snow or ice 29, at or in close proximity to the sensor 52f occurs. When buildup of cumulable substance 22, e.g., temperature-dependent accumulable substance 28, occurs, such as by condensation, freezing, sticking, clinging or otherwise adhering to part of an outer surface 24 of an external portion 26 of vehicle 20 at, on or in close enough proximity to sensor 52f to trigger the sensor 52f, driver energizing signal is outputted to the controller 48 preferably generating a driver energizing controller interrupt thereby causing the controller 48 to energize one or more drivers 44a, 44b, 44c and/or 44d in response.

In a preferred system embodiment equipped with a sensing arrangement 50 that employs both a humidity sensor 52a and a temperature sensor 52b, the controller 48 can be and preferably is configured, such as in firmware, software and/or hardware, to energize one or more of the drivers 44a, 44b, 44c and/or 44d of subsystem 42a when (a) the sensed humidity reaches or exceeds a first threshold humidity and the sensed temperature reaches or is less than a first threshold temperature, e.g., dew point temperature, indicative of substance accumulation beginning or being likely to occur due to temperature-dependent cumulable substance 28, e.g., water, condensing on wheel liner(s) 30 and/or underbody panel(s) 36 as a result of moisture-condensing humidity and temperature conditions outside the vehicle 20, (b) the sensed humidity reaches or exceeds a second threshold humidity and the sensed temperature reaches or is less than a second threshold temperature, e.g., freezing temperature, indicative of substance accumulation beginning or being likely to occur due to a temperature-dependent cumulable liquid substance 28, such as water freezing on wheel liner(s) 30 and/or underbody panel(s) 36 forming slush or ice 29 as a result of freezing humidity and temperature conditions outside the vehicle 20, and/or (c) the sensed humidity falls within an accumulation humidity range or zone and the sensed temperature reaches or is less than a third threshold temperature that can either be the same as one or both of the first and second threshold temperatures indicative of substance accumulation occurring or being likely to occur due to snow and/or slush 29 accumulating on wheel liner(s) 30 and/or underbody panel(s) 36 as a result of the corresponding snow or slush accumulation related humidity and temperature conditions outside the vehicle 20. In another preferred system embodiment equipped with a sensing arrangement 50 that employs a humidity sensor 52a, a temperature sensor 52b, and a pressure sensor 52e that is a barometric pressure sensor, the controller 48 can be and preferably is configured, such as in firmware, software and/or hardware, to energize one or more of the drivers 44a, 44b, 44c and/or 44d of subsystem 42a when the sensed humidity is at or greater than a threshold humidity and the sensed temperature is at or less than a threshold temperature, e.g., dew point temperature and/or freezing temperature for a (i) given barometric pressure or barometric pressure range, and/or (ii) rate of change of barometric pressure being within a predetermined range or boundary indicative of ambient or weather conditions outside the vehicle 20 being conducive to accumulation of substance 22, such as in the form of a temperature-dependent accumulable liquid substance 28, such as condensing or freezing water and/or snow or slush 29 being sticky enough to accumulate.

When one or more of the sensors 52a, 52b, 52c, 52d, 52e and/or 52f outputs a signal and/or data to the controller 48 of a corresponding sensed condition or sensed condition combination of the respective sensor(s) 52a, 52b, 52c, 52d, 52e and/or 52f reaching or exceeding a predetermined threshold or trigger and/or falling within a predetermined trigger range, zone, boundary, or map indicative of ambient or external conditions outside of the vehicle 20 being present that (a) would begin causing accumulation of a cumulable substance on the vehicle, (b) would cause accumulation of a cumulable substance on the vehicle, and/or (c) shows accumulation of an accumulable substance 22 on the vehicle, the controller 48 actuates one or more of the oscillatory drivers 44a, 44b, 44c and/or 44d to prevent or shed accumulation via oscillation or vibration. As previously indicated, each one of the oscillatory drivers 44a, 44b, 44c and/or 44d is a vibratory element that preferably is a vibratory motor 54, e.g. vibration motor 54, which more preferably is an eccentric mass or linear resonant actuator 56 in contact with or otherwise acoustically or vibrationally coupled to an exterior portion 26 of the vehicle 20, such as wheel liner 30 or underbody panel 36, where such an accumulable substance 22 accumulates or tends to accumulate. In a preferred embodiment, each one of the oscillatory drivers 44a, 44b, 44c and/or 44d is a linear resonant actuator 56 mounted to, on or in, e.g., embedded in, wheel liner 30 or underbody panel 36 in a manner where actuator vibration vibrates at least the outer surface 24 of the liner 30 or panel 36 sufficiently to prevent or shed accumulation.

The wheel liner 30 or underbody panel 36 can be and preferably is constructed with one or more oscillatory drivers 44a, 44b, 44c and/or 44d, attached to, mounted on, embedded in, or otherwise carried by the liner 30 or panel 36 such that a majority, if not substantially all, of the oscillatory, acoustic or vibratory energy 45 emitted, irradiated, generated or outputted therefrom is transferred to the liner 30 or panel 36 oscillating or vibrating the liner 30 or panel 36 and its outer surface 24 in a manner preventing or shedding accumulation on the outer surface 24. In a preferred wheel liner or underbody panel embodiment, embedding at least the oscillatory drivers 44a, 44b, 44c and/or 44d during molding or forming produces an oscillatory or vibration driven accumulation shedder panel 35a (shown in phantom or dashed lines in FIG. 3) in accordance with the present invention well suited for use as an oscillatory driven accumulation shedding wheel liner 30a or a vibration driven underbody shedder panel 36a. In one embodiment, at least one, preferably at least a plurality, and more preferably all the drivers 44a, 44b, 44c and/or 44d of an oscillatory driven accumulation shedding subsystem 42a thermoformed, vacuum formed, blow molded, injection molded, or otherwise formed or molded together in or with a plastic, composite and/or fibrous material to produce such an oscillatory or vibration driven accumulation shedder panel, whose construction, composition, shape, contour, exterior, and the like can be configured or otherwise adapted for vehicle exterior use as a finished oscillatory driven accumulation shedding wheel liner 30a or a finished vibration driven underbody shedder panel 36a in which the drivers 44a, 44b, 44c and/or 44d, including any vibration motor(s) 54 or linear resonant actuator(s) 56 thereof, are preferably substantially completely embedded therein. Although not shown in FIG. 3, such a shedder panel 35a can also be molded or otherwise integrally formed in a manner in which one or more of the sensors 52a, 52b, 52c, 52d, 52e and/or 52f of sensing arrangement 50 and/or part or all of the controller 48, is at least partially embedded and/or encapsulated therein such as by thermoforming, vacuum forming, blow molding, injection molding, or otherwise molding and/or integrally forming sensors 52a, 52b, 52c, 52d, 52e and/or 52f and/or controller 48 together with drivers 44a, 44b, 44c and/or 44d with or in such a plastic, composite and/or fibrous material to produce a driver-embedded and/or sensor-embedded shedder panel 35a which also can carry controller 48 as well as embed the controller 48 therein.

While an accumulation shedder panel 35a constructed in accordance with the invention can be molded of plastic, a composite material and/or a fibrous material, a preferred shedder panel 35a has a sheet-like panel body 37 composed of a molded, shapeable, or otherwise formable fibrous material 39, which can be of multi-layer or multiple layer construction, e.g., having a plurality or a plurality of pairs of, i.e., at least three, layers, with at least one of the layer and preferably at least a plurality of the layers being fibrous layers or of fibrous construction. One preferred fibrous material well suited for use in producing such a preferred shedder panel 35a is a moldable or formable multilayer fibrous material which preferably is thermally and/or vacuum formable or moldable that preferably also is of thermally insulating and/or acoustically insulating, e.g., sound deadening, construction that preferably is a thermoformable multilayer fibrous material like that, similar to or substantially same as disclosed in one or both of commonly owned U.S. Pat. Nos. 8,590,669 and/or 8,418,806, the disclosure of each of which is hereby expressly incorporated by reference herein in its entirety. When molding, shaping, or otherwise forming such a shedder panel 35a in accordance with the invention that includes one or more (a) drives 44a, 44b, 44c and/or 44d, e.g. vibration motor(s) 54 and/or linear resonant actuator(s) 56, (b) sensors 52a, 52b, 52c, 52d, 52e and/or 52f, and/or (c) controller 48 integrally formed or molded with the shedder panel 35a and embedded therein, one or more of the (i) drives 44a, 44b, 44c and/or 44d, e.g. motor(s) 54 and/or actuator(s) 56, (ii) sensors 52a, 52b, 52c, 52d, 52e and/or 52f, and/or (iii) controller 48 can be embedded, received or otherwise disposed in one or more openings, pockets, voids, channels, and/or recesses formed in one or more layers of a panel body 37 made of such a formable or moldable multilayer fibrous material and/or sandwiched between layers of such multilayer fibrous material like that disclosed in one or more of U.S. Pat. Nos. 8,590,669 and/or 8,418,806, to facilitate integrally forming or molding of the same in a manner that embeds them therewithin.

FIG. 4 schematically illustrates an embodiment of a second preferred accumulation subsystem 42b of an accumulation shedding system 40 of the present invention that is a thermally driven accumulation shedding subsystem 42b which is equipped with one or more thermal drivers 58a, 58b, 58c and/or 58d in place of oscillatory drivers 44a, 44b, 44c and/or 44d but which also has a controller 48 configured in firmware, software and/or hardware, with one or more methods of accumulation shedding system operation similar to and/or substantially same as the oscillatory subsystem 42 shown in FIG. 3 and described above. Each thermal driver 58a, 58b, 58c, and/or 58d preferably is or includes a heating element 60, which can be a thermoelectric heating element, e.g. Peltier effect device, but which more preferably is an electrically powered resistive heating element 62. During thermally driven subsystem operation, controller 48 monitors signals or data from sensing arrangement 50 and/or from one or more onboard electrical or control systems, and energizes one or more thermal drivers 58a, 58b, 58c, and/or 58d conditions within or outside the vehicle 20 warrant causing the heating element 60 of each energized driver 58a, 58b, 58c, and/or 58d to heat up at least part of an outer surface 24 of external portion(s) 26 of the vehicle 20 adjacent the energized driver(s). During operation, controller 48 preferably is configured to selectively and/or controllably, e.g., variably, energize one, a plurality of, a plurality of pairs of, or all the thermal drivers 58a, 58b, 58c, and/or 58d of subsystem 42b, to heat up at least part of an outer surface 24 of the exterior portion 26 of vehicle 20, e.g., wheel liner 30 or underbody panel 36, to a temperature greater than ambient atmosphere condensation temperature, e.g., higher than dew point temperature, or to a temperature greater than freezing, e.g., greater than 0° Celsius or 32° Fahrenheit, to prevent or shed accumulation depending on vehicle operating conditions and/or conditions outside the vehicle 20. The associated heating element 60 of each thermal driver 58a, 58b, 58c, and/or 58d is electrically powered or energized by controller 48 during operation thereby heating at least an adjacent part of the outer surface 24 of the wheel liner 30 or underbody panel 36 to a temperature high enough to at least prevent an accumulable substance 22, which typically is a temperature-dependent aqueous substance 28, like moisture, water, snow, slush, ice or another aqueous substance 29, from condensing, freezing or otherwise sticking to or adhering on the outer liner or panel surface 24.

Each heating element 60, e.g. resistive heating element 62, is disposed in close enough proximity to the wheel liner 30 or underbody panel 36 equipped with the thermally driven subsystem 42b for the heating element 60 to thermally couple with the liner 30 or panel 36 in a manner where at least some of the heat energy 64, e.g., radiant heat energy 64, emitted or irradiated from the heating element 62 heats, e.g., radiantly heats, the liner 30 or panel 36 enough for its outer surface 24 to reach a temperature greater than at least the dew point temperature and/or the freezing temperature that is high enough to prevent or shed accumulation thereon. While radiant heat 64 can be the mode of heat transfer employed to heat up the outer liner or panel surface 24 where there is a gap between the heating element 60 and the liner 30 or panel 36, heating element 60 preferably is disposed in contact with the liner 30 or panel 36 so that the heat energy outputted by the element 60 is more efficiently transferred via conduction from the element 60 directly to the liner 30 or panel 36.

In a preferred embodiment of a thermally driven accumulation shedder wheel liner 30 or underbody panel 36 constructed in accordance with the present invention equipped with one or more thermal drivers 58a, 58b, 58c, and/or 58d, the heating element 60, preferably resistive element 62, of each driver 58a, 58b, 58c, and/or 58d is attached to, mounted on, embedded in, or otherwise carried by the liner 30 or panel 36 in a manner where a majority, if not substantially all, of the heat energy emitted, irradiated, generated or outputted is transferred to the liner 30 or panel 36 via conduction with perhaps some radiant heat transfer also taking place. In one preferred embodiment, the heating element 60 of each driver 58a, 58b, 58c, and/or 58d of such a thermally driven accumulation shedding wheel liner 30 or underbody panel 36 of the present invention is either embedded or encapsulated in the liner 30 or panel 36, such as by being integrally molded or formed therewith, and/or is mounted to or on the outer surface 24 of the liner 30 or panel 36.

In one preferred embodiment, each heating element 60 can be composed of elongate resistive conductors or resistive wires arranged to form at least a plurality, preferably at least a plurality of pairs of, at least three, generally parallel resistive conductor or wire segments interconnected by one or more resistive conductor or wire segments extending generally transversely therebetween forming a heating grid, e.g., defrosting grid, heating array, e.g., defrosting array, or other pattern defining a defrosting heating element grid (not shown) or defrosting heating element array that is attached to, mounted on, embedded in, or otherwise carried by the liner 30 or panel 36. In one such preferred embodiment where the heating element 60 of one or more of the thermal drivers 58a, 58b, 58c, and/or 58d is or includes such a heating element grid, e.g. defroster grid, or heating element array, e.g. defroster array, the heating element grid or heating element array of the heating element 60 of one or more of the thermal drivers 58a, 58b, 58c, and/or 58d can be mounted to the liner 30 or panel 36, attached, e.g. adhesively attached, to the outer surface 24 of the liner 30 or panel 36, or embedded in the liner 30 or panel 36, such as by being integrally molded or otherwise formed with or as part of the liner 30 or panel 36. Where thermally driven subsystem 42b is equipped with one or more sensors, e.g., one or more sensors 52a, 52b, 52c, 52d, 52e and/or 52f, and/or sensing arrangement 50, one or more of the sensors 52a, 52b, 52c, 52d, 52e and/or 52f can likewise be mounted to the liner 30 or panel 36, attached, e.g. adhesively attached, to the outer surface 24 of the liner 30 or panel 36, or embedded in the liner 30 or panel 36, such as by being integrally molded or otherwise formed with or as part of the liner 30 or panel 36.

In a preferred thermally driven accumulating shedding wheel liner or underbody panel embodiment, embedding or encapsulating at least the thermal drivers 58a, 58b, 58c, and/or 58d during molding or forming produces a thermally driven accumulation shedder panel 35b (shown in phantom or dashed lines in FIG. 4), e.g., accumulation shedder panel wheel liner 30b or accumulation shedder underbody panel 36b, in accordance with the present invention well suited for use as a thermally driven accumulation shedder wheel liner 30b or thermally driven accumulation shedder underbody panel 36b. As such, a thermally driven accumulation shedder panel 35b of the present invention that is equipped with thermally driven subsystem 42b can be and preferably is molded, shaped, formed or otherwise produced in a manner similar to or same as that of the oscillatory or vibration driven shedder panel 35a equipped with oscillatory or vibration driven subsystem 42a disclosed above with one or more or all of the drivers 58a, 58b, 58c, and/or 58d at least partially embedded in and/or substantially completely encapsulated within a panel body 37 formed of moldable or formable fiber material 39, including material similar to or same as disclosed in commonly owned U.S. Pat. Nos. 8,590,669 and/or 8,418,806. One or more sensors 52a, 52b, 52c, 52d, 52e and/or 52f and the controller 48 can also be embedded in or encapsulated within the panel body 37 of shedder panel 35b well suited for use as a thermally driven accumulation shedding wheel liner 30b or thermally driven accumulation shedding underbody panel 36b. Where one or more thermal drivers 58a, 58b, 58c, and/or 58d includes or is formed of a resistive heating element 62, each such resistive heating element 62 in the form of a grid, e.g., defroster grid, array, or the like, can be attached, affixed or otherwise fixed to a surface, preferably outer surface 24, of shedder panel 35b and can also be embedded in and/or encapsulated within the body 37 of the panel 35b, including during or as a result of molding or forming of the panel 35b.

FIG. 5 schematically depicts an embodiment of a third preferred accumulation shedding subsystem 42c that is a hybrid or dual-action accumulation shedding subsystem 42c in accordance with the present invention that includes at least (a) one or more oscillatory drivers 44a and/or 44b, (b) one or more thermal drivers 58a and/or 58b, and (c) controller 48 which is linked to or interfaces with a sensing arrangement which can be composed of or linked to one or more sensors 52a, 52b, 52c, 52d, 52e and/or 52f that can also form part of the subsystem 42c. If desired, controller 48 can link to or interface with sensing arrangement(s) comprised of one or more onboard vehicle control systems and/or one or more vehicle sensors instead of or in addition to sensing arrangement 50 and/or sensors 52a, 52b, 52c, 52d, 52e and/or 52f. In accordance with that disclosed elsewhere herein, controller 48 is configured in firmware, software and/or hardware to monitor or poll at least one sensor and preferably at least one sensing arrangement, e.g. sensing arrangement 50 and/or sensing arrangement provided by one or more vehicle controllers, for sensor signals, sensor-related data, and/or sensor-related or sensor-generated interrupts indicative of conditions which would cause buildup of an accumulable substance 22, such as a temperature-accumulable aqueous substance 28, e.g., moisture, water, snow, slush and/or ice 29, and accordingly energizes one or more of the oscillatory drivers 42a and/or 42b and/or one or more of the thermal drivers 58a and/or 58b.

In the preferred embodiment of the hybrid or dual-action subsystem 42c depicted in FIG. 5, the subsystem 42c employs at least a plurality of oscillatory drivers 44a and 44b and at least a plurality of thermal drivers 58a and 58b controlled by a common controller 48 linked to a sensing arrangement 50 comprised of one or more sensors 52a, 52b, 52c, 52d, 52e and/or 52f monitored by controller 48 substantially in accordance with one or more methods of controller operation disclosed hereinabove with regards to subsystems 42a and/or 42b with actuation or energization of drivers 44a, 44b, 58a and/or 58b being controlled by controller 48 substantially in accordance with controller methods of operation disclosed hereinabove for subsystems 42a and/or 42b. As with the shedder panel 35a and 35b discussed above in conjunction with FIGS. 3 and 4, a hybrid or dual-action accumulation shedder panel 35c is schematically depicted in FIG. 5 has having a panel body 37 which can be composed of or otherwise include one or more layers of a fibrous material 39, such as fibrous material same as or like that of the multilayer fibrous material disclosed in one or more of commonly owned U.S. Pat. Nos. 8,590,669 and/or 8,418,806. As with the panels 35a and 35b respectively of FIGS. 3 and 4, shedder panel 35c can also be molded or otherwise integrally formed in a manner that attaches, affixes, embeds, and/or encapsulates one or more of the drivers 44a, 44b, 58a and/or 58b, sensors 52a, 52b, 52c, 52d, 52e and/or 52f, and/or the controller 48 to, on, in and/or within a body 37 of the shedder panel 35c that can be composed of fibrous material 39.

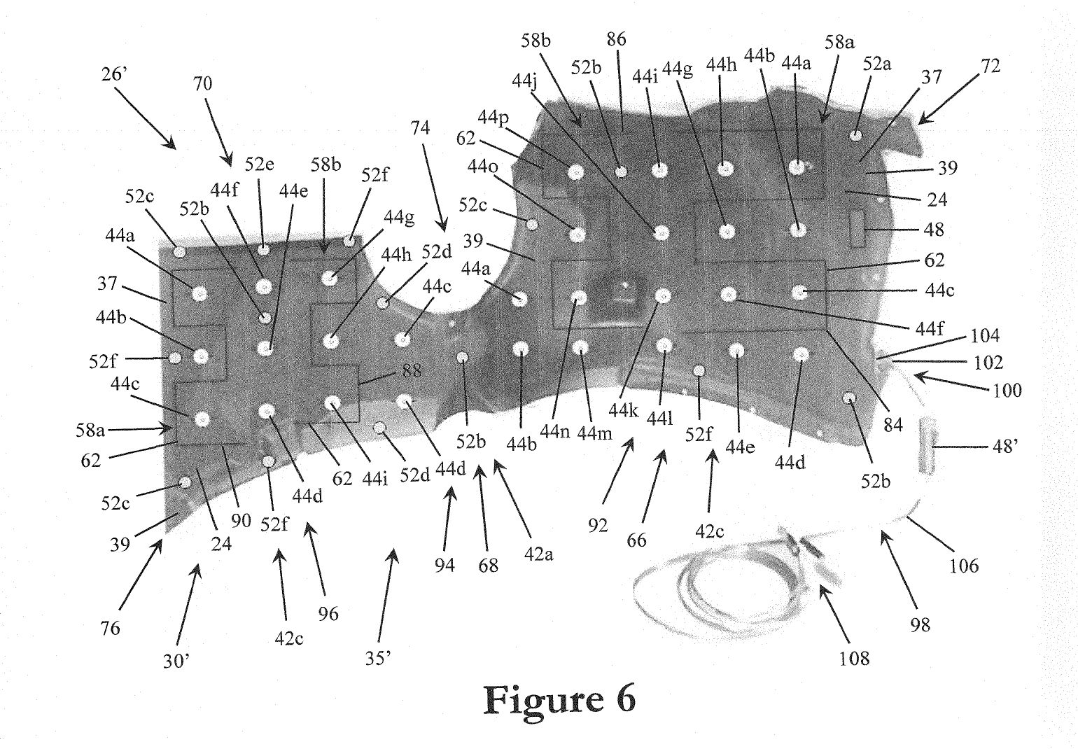

FIG. 6 illustrates a preferred but exemplary embodiment of a three-dimensionally contoured shedder panel 35′, constructed in a manner same as or similar to that disclosed above and/or depicted in FIGS. 3-5, which preferably is a three-dimensionally contoured concave substance accumulating shedder panel wheel liner 30′, constructed with at least one accumulation shedding subsystem, e.g., subsystem 42a, 42b and/or 42c, onboard and preferably integral with the panel 35′ such as by being made, molded or otherwise formed by or with the drivers 44a, 44b, 44c and/or 44d and/or 58a, 58b, 58c and/or 58d, sensors 52a, 52b, 52c, 52d, 52e and/or 52f, and/or controller 48 of one or more subsystems 42a, 42b and/or 42c onboard the shedder panel 35′ being integrally incorporated therein preferably by being affixed on, mounted to, embedded in and/or encapsulated within the outer surface 24 and/or panel body 37 of the panel 35′.

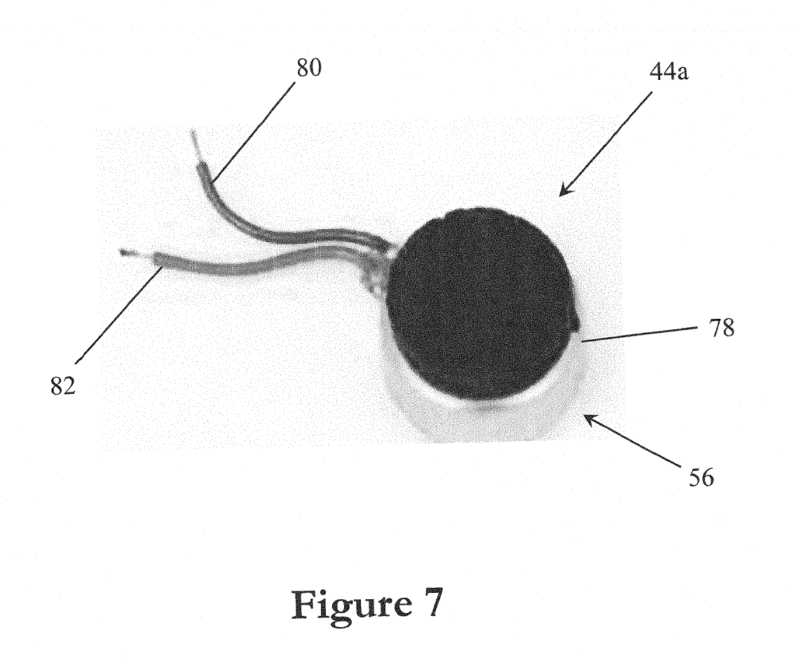

The shedder panel 35′ shown in FIG. 6 has a plurality of pairs of sets of oscillatory drivers 44a-44i, 44a-44d, and 44a-44o, embedded in or housed within the panel body 37 which are arranged in at least a plurality, preferably at least a plurality of pairs of, rows and/or columns of the vibratory actuators 44a-44i, 44a-44d, and 44a-44o forming at least one vibratory driver matrix or grid and preferably forming a plurality of vibratory driver matrices or grids 66, 68 and 70 whose operation is independently controller by controller 48 during operation. With continued reference to FIG. 6, vibratory grids 66 and 70 are respectively situated on a pair of generally rectangular panel sections 72 and 74 of the shedder panel 35′ which are spaced apart by a narrower adjoining panel section 76 interconnecting panel sections 72 and 74 on which vibratory grid 68 is situated. With reference to FIG. 7, each oscillatory driver 44a-44i, 44a-44d, 44a-44o, of the shedder panel 35′ shown in FIG. 6 preferably is a linear resonant actuator 56 formed of a vibration motor body 78 having a pair of electrical wires or leads 80 and 82 extending outwardly therefrom through which electrical power is supplied to vibrate the actuator 56 when energized by the controller 48 during accumulation shedding system operation. Shedder panel 35′ also has a plurality of pairs of thermal drives 58a, 58b, 58c and 58c with each thermal drive 58a, 58b, 58c and 58c preferably formed of an elongate serpentine or zig-zag resistive heating element 62 each forming an accumulation preventing of shedding defroster grid 84, 86, 88 and 90, attached to, affixed on, embedded in, or enclosed within the outer surface 24 of the panel 35′. Such a shedder panel 35′ preferably is composed of a plurality, preferably a plurality of pairs of hybrid or dual-action subsystems 42c spaced apart from one another, e.g., disposed side-by-side to one another, defining at least a plurality, preferably at least a plurality of pairs of accumulation shedding control zones 92, 94 and 96 which are independently operable or energizable by the controller 48 during accumulation system shedding operation. Shedder panel 35′ also includes a wiring harness 98 with a connector 100, such as a plug 102, at one end that can removably plug into a receptacle 104 of the panel 35′ with the wiring harness 98 having at least one elongate flexible wiring cable 106 composed of a plurality of wires, including electrical power wires, vehicle control system data communication wires, sensor signal communicating wires, data-carrying wires, and/or the like, which connect to the vehicle 20 onto which the panel 35′ is attached. Where the controller 48 is not disposed onboard the panel 35′, such as depicted in FIG. 6, controller 48′ alternatively can be connected to or be part of the wiring harness 98 in the manner further depicted in FIG. 6. If desired, an opposite end of the wiring harness 98 can be equipped with a connector 108, such as a plug 110 or the like, which is configured for plug-and-play connection to the vehicle 20 when the panel 35′ is assembled thereto.

Where any of the shedder panels 35a, 35b, and/or 35c have a panel body 37 formed partially or substantially completely of fibrous material 39, the fibrous material preferably is a thermoplastically moldable fiber-containing material, at least a portion of which can be formed or composed of carpet and/or carpet fiber, thermoplastic polymer fibers, a thermoplastic fiber blend, or the like. Suitable fibrous material 39 from which panel body 37 can be formed can be composed of one or more of polyethylene terephthalate (PET) fibers, polyolefin fibers, e.g. polyethylene and polypropylene fibers, polyamide fibers, polyester fibers, thermoplastic polyurethane fibers, polycarbonate fibers, and/or polyacetal fibers, as well as fibers made of copolymers and blends of these fibers.

The fibrous material 39 of one or more layers of the panel body 37 and the three-dimensionally formed oscillatory and/or thermally driven accumulation shedder panel 35a, 35b and/or 35c made therefrom can also be of composite fiber construction having at least one type of thermoplastic fiber, e.g., thermoplastic polymer resin fiber, used to produce a woven or non-woven fiber blend formed into a thermoplastically moldable composite fiber sheet that provides a composite fiber blank from which a fibrous material panel body that preferably is a composite fiber panel body is thermally molded into the desired three dimensional shape of the shedder panel 35a, 35b, or 35c which is substantially retained after molding is done. The thermoplastic fiber blend can be made of polyethylene terephthalate (PET) fibers, polyolefin fibers, e.g. polyethylene and polypropylene fibers, polyamide fibers, polyester fibers, thermoplastic polyurethane fibers, polycarbonate fibers, and/or polyacetal fibers, as well as copolymers and blends thereof. The fiber blend can include one or more other types of fibers, including reinforcing fibers, such as glass fibers, carbon fibers, basalt fibers and/or aramid fibers, and/or natural fibers, such as flax fibers, jute fibers, hemp fibers, sisal fibers and/or cotton fibers blended with the thermoplastic fibers. One suitable fiber blend is made of one or more types of thermoplastic fibers blended or formed into a thermoplastically moldable composite fiber sheet that can and preferably does have an outer fibrous surface, such as a carpet surface that can be a needle punch carpet surface. If desired, one or more types of reinforcing fibers and/or one of more types of natural fibers can be blended with thermoplastic fibers to produce a woven or non-woven blend formed into a thermoplastically moldable composite fiber sheet that can also have a carpet surface, such as a needle punch carpet surface.

The outer surface 24 of panel body 37 of shedder panel 35a, 35b and/or 35b can be formed or covered by a coating material, e.g., spray-on coating material, such as urethane, an epoxy, or the like, which is sprayed on and allowed to solidify, harden or cure forming an outer layer that is more durable, tougher, and/or water-impervious. Where outer surface 24 of panel body 37 of shedder panel 35a, 35b and/or 35b is formed during or by a molding or forming operation, polyurethane, polyureas, polyisocyanurates, polyesters, polyphenols, polyepoxides, epoxies, and/or nylon 6 can be molded or formed around the body 37, such as by being reaction injection molded, producing an outer surface 24 that is harder, tougher, more resilient, more durable and/or water-impervious. If desired, the outer surface 24 of panel body 37 of shedder panel 35a, 35b and/or 35b can also be formed of polyurethane, polyethylene, polypropylene, nylon, polycarbonate, acrylonitrile butadiene styrene (ABS), acetal, acrylic, epoxy, aluminum, polyester, polystyrene, and/or polybutylene that is formed by molding, preferably rotational molding, around the panel body 37 forming a shedder panel surface 24 of relatively durable, tough and water-tight construction. Outer shedder panel surface 24 can also be formed of one or more of these materials and/or other material(s) which are sprayed on, molded around or otherwise applied to the panel body 37 with one or more of the drivers 44a, 44b, 44c and/or 44d and/or 58a, 58b, 58c and/or 58d, sensors 52a, 52b, 52c, 52d, 52e and/or 52f, and/or controller 48 mounted on, attached to, embedded in, and/or encapsulated within the outer surface 24 of the shedder panel body 37 in producing a shedder panel 35a, 35b and/or 35c in accordance with the present invention.

One or more materials, including fibrous materials, as well as one or more methods of forming or molding such materials well suited for use in making such a vibration driven and/or thermally driven accumulation shedder panel 35a, 35b and/or 35c in accordance with the present invention are disclosed in one or more of commonly owned U.S. Pat. Nos. 8,590,669, and 8,418,806, and U.S. Patent Application Publication No. US 20150158539 A1, the disclosures of each of which are hereby expressly incorporated herein by reference.

In a preferred accumulation shedding system and/or method of the present invention, one or more exterior panels of the vehicle are configured with, equipped with or otherwise include one or both of an oscillatory driven accumulation shedding subsystem 42a, a thermally driven accumulation shedding subsystem 42b, and/or a hybrid dual-action oscillatory and thermally driven accumulation shedding subsystem 42c operatively connected to at least one processor-equipped controller 48 configured in hardware, firmware and/or software to control operation of the drivers 44a, 44b, 44c, 44d, 58a, 58b, 58c and/or 58d of subsystem(s) 42a, 42b and/or 42c of each shedder body panel 35a, 35b and/or 35c exteriorly mounted to vehicle 20. In a preferred embodiment, controller 48 can be linked to a sensing system 50 with one or more sensors 52a, 52b, 52c, 52d, 52e and/or 52f as disclosed above but can also be connected to an ambient, vehicle exterior and/or weather conditions monitoring system of the vehicle 20, e.g., an exterior temperature monitoring system which monitors at least the temperature outside the vehicle 20, instead of or in addition to being connected to sensing arrangement 50 and/or sensors 52a, 52b, 52c, 52d, 52e and/or 52f. Where linked to such an exterior vehicle conditions monitoring system, preferably an exterior temperature monitoring system, which provides the controller 48 with at least the temperature and/or pressure outside the vehicle 20, such a subsystem 42a, 42b and/or 42c can be configured without sensors 52a, 52b, 52c, 52d, 52e and/or 52f and/or sensing system 50 if desired. In another preferred accumulation shedding system or subsystem control regime, controller 48 can be linked to an onboard vehicle controller, such as the ECU, EEC module, or the like, but which preferably is linked the onboard chassis control system and/or one or more sensors thereof and configured in firmware, software and/or hardware to energize at least one or more and preferably all of the oscillatory drivers 44a, 44b, 44c, and/or 44d of each subsystem 42a, 42b and/or 42c and/or of each shedder panel body 35a, 35b and/or 35c of the vehicle 20 equipped with system 40 when the vehicle stability system is engaged, such as when the antilock brakes are pulsed when wheel slip is detected.

Such an accumulation shedding system controller 48 can tie into, be part of or otherwise operatively connect with at least one control system of the vehicle such as by being electrically connected or in electrical communication with the onboard CANBUS and/or EEC module of the vehicle. As such, the accumulating shedding system controller can also be connected with or otherwise tie into one or more of the onboard sensors of the vehicle, including one or more temperature, pressure and/or humidity sensors of the vehicle, in monitoring ambient conditions exteriorly of the vehicle in the controller being configured in hardware, software and/or firmware to selectively operate one or both of the oscillatory driven accumulation shedding subsystem and/or the thermally driven accumulation shedding subsystem of the entire accumulation shedding system and/or selectively operate one or both of the oscillatory driven accumulation shedding subsystem and/or the thermally driven accumulation shedding subsystem of one or more of the accumulation shedder panels.

While it is contemplated that a vehicle equipped with an accumulation shedding system of the present invention has one or more shedder panels installed on exterior portions of the vehicle, it is also contemplated that such an accumulation shedding system can be configured to employ one or both an oscillatory driven accumulation shedding subsystem and/or a thermally driven accumulation shedding subsystem that attaches to, mounts on, or otherwise installs onto, into or with one or more already existing exterior panels of a vehicle to which the accumulation shedding system is being installed. As such, where an accumulation shedding system of the invention employs one or more accumulation shedder panels, each shedder panel is preferably installed exteriorly on or of the vehicle in at least one location where ice, snow, dirt, dust, debris, dirt, mud, or another type of material tends to accumulate. In this regard, it is contemplated that one or more of the accumulation shedder panels can be configured or otherwise adapted to fit over, attach to, mount on, or otherwise adhere to a corresponding already existing exterior panel of the vehicle. Where an accumulation shedding system of the invention does not use any accumulation shedder panels, one or more oscillatory driven accumulation shedding subsystem(s) and/or thermally driven accumulation shedding subsystem(s) are mounted to, in or on one or more corresponding existing exterior panels of the vehicle in at least one location where ice, snow, dirt, dust, debris, or another type of material tends to accumulate. Whether employing one or more accumulation shedder panel(s), being of panel-less construction, or being of hybrid accumulation shedder panel and panel-less construction, an accumulation shedding system constructed in accordance with the present is well suited for original equipment manufacturer and retrofit installation.

An accumulation shedding system of the present invention is equipped with at least one accumulation shedding subsystem that is mounted onboard or otherwise carried by the vehicle in a position or location where actuation or operation of the accumulation shedding subsystem either causes accumulation to be shed or prevents accumulation from occurring. An accumulation shedding subsystem of the present invention can be equipped with one or more oscillatory accumulation shedding drivers, one or more thermal accumulation shedding drivers, or a combination of one or more oscillatory accumulation shedding drivers and one or more thermal accumulation shedding drivers that can be part of an accumulation shedder panel or which can be of panel-less construction.

Understandably, the present invention has been described above in terms of one or more preferred embodiments and methods. It is recognized that various alternatives and modifications can be made to these embodiments and methods that are within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

1. A vehicle cumulable substance prevention system comprising:
a vibratory element vibrationally or acoustically coupled to one of a wheel liner and underbody panel of a vehicle that oscillates or vibrates an external surface of the one of the wheel liner and underbody panel to prevent or shed accumulation of a cumulable substance thereon;
a source of electrical power for electrically energizing the vibratory element; and
a controller configured to control energization of the vibratory element.

2. The vehicle cumulable substance prevention system of claim 1 further comprising a load cell configured to monitor external weight.

3. The vehicle cumulable substance prevention system of claim 2 wherein the load cell carried by or mounted to one of the wheel liner and underbody panel of the vehicle.

4. The vehicle cumulable substance prevention system of claim 3 wherein the vibratory element is carried by or mounted to the one of the wheel liner and underbody panel of the vehicle.

5. The vehicle cumulable substance prevention system of claim 4 wherein the controller is configured to electrically power the vibratory element once a predetermined load or weight of the one of the wheel liner and underbody panel is sensed using the load cell.

6. The vehicle cumulable substance prevention system of claim 5 wherein the vibratory element excites an outer surface of the one of the wheel liner and underbody panel to prevent or shed accumulation of a cumulable substance thereon.

7. The vehicle cumulable substance prevention system of claim 1 further comprising a temperature sensor, wherein the controller is configured to electrically power the vibratory element when a predetermined temperature, temperature range or threshold of the one of the wheel liner and underbody panel is sensed using the temperature sensor.

8. The vehicle cumulable substance prevention system of claim 1 further comprising a manual actuator that is manually operable to electrically power the vibratory element.

9. The vehicle cumulable substance prevention system of claim 1 wherein the controller is synched with an anti-lock brake mechanism of the vehicle such that electrical power is provided to the vibratory element when the anti-lock brake mechanism pulses.

10. The vehicle cumulable substance prevention system of claim 1 wherein the one of the wheel liners and underbody panels has a plurality of spaced apart vibratory elements mounted thereto.

11. The vehicle cumulable substance prevention system of claim 10 where each one of the vibratory elements comprises a vibration motor.

12. The vehicle cumulable substance prevention system of claim 10 where each one of the vibratory elements comprises a piezoelectric transducer.

13. The vehicle cumulable substance prevention system of claim 1 further comprising an electrical heating element mounted the one of the wheel liner and underbody panel that is selectively energized by the controller to supply electrical power thereto to cause the heating element to heat up and melt snow, slush and ice that has accumulated on an external surface of the one of the wheel liner and underbody panel to which the heating element is mounted.

14. The vehicle cumulable substance prevention system of claim 13 wherein the one of the wheel liner and underbody panel has a plurality of spaced apart electrical heating elements mounted thereto.

15. The vehicle cumulable substance prevention system of claim 14 wherein the one of the wheel liner and underbody panel has a plurality of spaced apart vibratory elements mounted thereto.

16. The vehicle cumulable substance prevention system of claim 17 wherein the controller is configured to control operation of the vibratory elements and the heating elements independently of one another.

17. The vehicle cumulable substance prevention system of claim 1 further comprising a heating element mounted the one of the wheel liner and underbody panel that is selectively energized by the controller to supply electrical power thereto to cause the heating element to heat up to prevent moisture, snow, slush and ice from accumulating on an external surface of the one of the wheel liner and underbody panel to which the heating element is mounted.

18. The vehicle cumulable substance prevention system of claim 17 wherein the one of the wheel liner and underbody panel has a plurality of spaced apart electrical heating elements mounted thereto.

19. The vehicle cumulable substance prevention system of claim 18 wherein the one of the wheel liner and underbody panel has a plurality of spaced apart vibratory elements mounted thereto.

20. The vehicle cumulable substance prevention system of claim 19 wherein the controller is configured to control operation of the vibratory elements and the heating elements independently of one another.
